(19) United States
(12) Patent Application Publication
(10) Pub. No.: US 2026/0142786 A1
(43) Pub. Date: May 21, 2026

(54) METHOD, APPARATUS AND SYSTEM FOR DATA TRANSMISSION

(71) Applicant: Huawei Technologies Co., Ltd., Shenzhen (CN)

(72) Inventors: Wen Tong, Ottawa (CA); Jianglei Ma, Ottawa (CA); Huazi Zhang, Zhejiang (CN)

(21) Appl. No.: 19/445,080

(22) Filed: Jan. 9, 2026

Related U.S. Application Data
(63) Continuation of application No. PCT/CN2024/088980, filed on Apr. 19, 2024.
(60) Provisional application No. 63/513,043, filed on Jul. 11, 2023.
(60) Provisional application No. 63/513,040, filed on Jul. 11, 2023.

(51) Int. Cl. H04L 5/00; H04L 1/1812

(52) U.S. Cl. CPC H04L 5/0094; H04L 1/1819; H04L 5/0055

(57) ABSTRACT

A method is provided. The method includes: sending one or more sets of bits of a first codeword on a first resource; sending one or more sets of bits of a second codeword on a first part of a second resource; sending one or more sets of bits of the first codeword on a second part of the second resource; receiving feedback indicating the first codeword is decoded successfully; and terminating the sending of the one or more sets of bits of the first codeword in response to the feedback.

### CROSS-REFERENCE TO RELATED APPLICATIONS

This application is a continuation of International Patent Application PCT/CN2024/088980, filed on Apr. 19, 2024, which claims the benefit of U.S. Provisional Patent Application No. 63/513,043, filed on Jul. 11, 2023, and claims the benefit of U.S. Provisional Patent Application No. 63/513,040, filed on Jul. 11, 2023. The entire contents of these disclosures are hereby incorporated by reference.

### TECHNICAL FIELD

The present disclosure generally relates to the field of wireless communication, and in particular, to a method, apparatus and system for data transmission, and a computer readable storage medium.

### BACKGROUND

Two trends are observed toward 6G, one is the ever-crowded spectrum in the sub-3G bands, and the ever-increasing power saving demand.

The past generations of mobile communications (4G and 5G) have adopted higher frequency spectrums for larger bandwidth. However, due to the channel propagation characteristics, the coverage is much smaller than lower-frequency bands, say, sub-3 GHz. The power efficiency is also much lower. As a result, the operators are more willing to prioritize the use of lower bands for better coverage and power saving. As a result, the sub-3 Ghz bands will become even more crowded.

A key target of 6G is to reduce the global carbon footprint, at least does not increase the net energy consumption of 5G. However, denser deployment of wireless devices is expected, which naturally increases the inter-cell and inter-device interference. Reducing the transmit energy will have the double benefits of energy saving and interference mitigation, however at the cost of lower received signal-to-interference-plus-noise ratio (SINR). This is a dilemma.

With the current technology, there are several schemes to save transmission energy, improve spectral efficiency and enhance SINR. The first scheme is link adaptation and Hybrid automatic repeat request (hybrid ARQ or HARQ), and the second scheme is power adaptation. The link adaptation and HARQ methods suffer from low spectrum efficiency and excessive latency. The power adaptation suffers from low spectrum efficiency and low power efficiency.

This background information is provided to reveal information believed by the applicant to be of possible relevance to the present disclosure. No admission is necessarily intended, nor should it be construed, that any of the preceding information constitutes prior art against the present disclosure.

### SUMMARY

According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: sending one or more sets of bits of a first codeword on a first resource; sending one or more sets of bits of a second codeword on a first part of a second resource; sending one or more sets of bits of the first codeword on a second part of the second resource; receiving feedback indicating the first codeword is decoded successfully; and terminating the sending of the one or more sets of bits of the first codeword in response to the feedback.

In such case, the transmission of the first codeword may occupy the first resource and a part of the second resource. The transmission of the second codeword may be punctured by the transmission of the first codeword. In this way, if the first codeword is not successfully decoded by the end of the first resource, the first codeword will be opportunistically transmitted on other resources, and the transmission of the first codeword will not be limited within the first resource. Therefore, there will be more opportunities for transmission of the first codeword, and the possibility of decoding the first codeword successfully at the receiving apparatus will be increased.

In some embodiments, the method further comprises: sending a first indication for indicating at least one of: a proportion of the second part of the second resource in the second resource, a quantity of the second part of the second resource, or a distribution of the second part of the second resource in the second resource.

In this way, the transmitting apparatus may inform the receiving apparatus of the information about the second part of the second resource, and the receiving apparatus may know on which resource it will receive the first codeword.

In an implementation, the second part of the second resource is evenly distributed in the second resource; or, the second part of the second resource is distributed at the beginning of the second resource, at the end of the second resource, or at both the beginning and end of the second resource.

In this way, the transmitting apparatus may inform the receiving apparatus of the distribution of the second part of the second resource in the second resource.

In some embodiments, the second part of the second resource is used for transmitting parity bits.

In this case, the transmission of the parity bits of the second codeword may be punctured by the transmission of the first codeword, and information bits of the second codeword may not be punctured. As such, impact of puncture the transmission of the second codeword will be reduced.

In some embodiments, the method further comprising: sending one or more sets of bits of a third codeword on a first part of a third resource; sending one or more sets of bits of the first codeword on a second part of the third resource; and sending one or more sets of bits of the second codeword on a third part of the third resource.

In such case, the transmission of the third codeword may be punctured by the transmission of the first codeword and the transmission of the second codeword. In this way, if the first codeword is not successfully decoded, the first codeword will be opportunistically transmitted on the third resource. Similarly, if the second codeword is not successfully decoded, the second codeword will be opportunistically transmitted on the third resource. Therefore, there will be more opportunities for transmission of the first codeword and the second codeword, and the possibility of decoding the first codeword and the second codeword successfully at the receiving apparatus(es) will be increased.

In some embodiments, a time of sending an initial set of bits of the first codeword is earlier than a time of sending an initial set of bits of the second codeword, and the time of sending the initial set of bits of the second codeword is earlier than a time of sending an initial set of bits of the third codeword; and the one or more sets of bits of the second codeword are sent on the third part of the third resource after the one or more sets of bits of the first codeword are sent on the second part of the third resource.

In this way, transmission of the earlier or older codeword will be prioritized.

In some embodiments, a quantity of the second part of the second resource is greater than a quantity of the second part of the third resource.

In this way, more resources will be allocated to the earlier or older codeword.

In some embodiments, a proportion of the second part of the second resource in the second resource is greater than a proportion of the second part of the third resource in the third resource.

In this way, more resources will be allocated to the earlier or older codeword.

In some embodiments, the method further comprises: sending first information, wherein the first information is used for indicating a length of the one or more sets of bits of the first codeword, a starting position of the one or more sets of bits of the first codeword on time-frequency resource, or both the length of the one or more sets of bits of the first codeword and starting position of the one or more sets of bits of the first codeword on time-frequency resource; the length of the one or more sets of bits of the first codeword includes at least one of: a minimum transmission length of each of the one or more sets of bits of the first codeword, or a maximum transmission length of the one or more sets of bits of the first codeword.

In this way, the transmitting apparatus may inform the receiving apparatus of the resource for transmission of the first codeword or limitation of the resource for transmission of the first codeword.

In an implementation, the length of the one or more sets of bits of the first codeword is determined based on at least one of: a large scale channel quality indicator (CQI), a previous feedback, or a modulation and coding scheme (MCS).

In an implementation, the maximum transmission length is an integer multiple of the minimum transmission length.

In some embodiments, the sending the one or more sets of bits of the first codeword includes: sending the one or more sets of bits of the first codeword on first frequency domain resources.

In some embodiments, the method further comprises: sending second information to the first terminal device, wherein the second information includes a second indication of the first frequency domain resources.

In this way, the transmitting apparatus may inform the receiving apparatus of the information about the first frequency domain resources.

In an implementation, the second information includes one or more BWP index(es) or one or more carrier index(es).

In some embodiments, the first frequency domain resources are obtained through carrier aggregation.

In some embodiments, the receiving the feedback indicating the first codeword is decoded successfully includes: receiving the feedback on second frequency domain resources.

In some embodiments, the first frequency domain resources belong to FDD downlink bands, and the second frequency domain resources belong to FDD uplink bands.

In such case, the first frequency domain resources belong to FDD downlink bands, and the second frequency domain resources belong to FDD uplink bands.

In an implementation, a duration of transmitting the one or more sets of bits on the first frequency domain resources is same as a duration of a reporting window of the feedback on the second frequency domain resources.

In this way, there may be a feedback opportunity for each of the one or more sets of bits, and the decoding result of the first codeword will be reported in a timely manner.

In some embodiments, the first frequency domain resources and the second frequency domain resources are at least partially overlapped.

In an implementation, at least part of time domain resources, at least part of frequency domain resources, or at least part of the time domain resources and frequency domain resources are reserved for receiving the feedback corresponding to the first codeword.

In this way, there may be a feedback opportunity for each of the one or more sets of bits, and the decoding result of the first codeword will be reported in a timely manner.

In some embodiments, the method further comprises: sending a third indication to enable receiving apparatus to receive the one or more sets of bits of the first codeword on the first resource, to receive the one or more sets of bits of the second codeword on the first part of a second resource, and to receive the one or more sets of bits of the first codeword on the second part of the second resource.

In some embodiments, the method further comprises: terminating the sending of the one or more sets of bits of the first codeword when a total length of the one or more sets of bits of the first codeword that have been transmitted reaches the maximum transmission length.

In such case, the transmission of the first codeword may be limited within the maximum transmission length, thereby avoiding allocating too many resources for the transmission of the first codeword.

In some embodiments, the receiving the feedback indicating the first codeword is decoded successfully includes: receiving the feedback at one of one or more feedback opportunities, and the one or more feedback opportunities are periodic.

In some embodiments, the first information is carried in Radio Resource Control (RRC) signaling or Downlink Control Information (DCI).

In some embodiments, the first codeword is sent to a first terminal device, or the second codeword is sent to a second terminal device, or the first codeword is sent to a first terminal device and the second codeword is sent to a second terminal device.

In such case, the first codeword and the second codeword may be transmitted to different receiving apparatus.

In some embodiments, the method further comprises: receiving second feedback corresponding to the second codeword from the second terminal device on the second frequency domain resources.

In this way, the transmitting apparatus may receive the feedback corresponding to the first codeword and the feedback corresponding to the second codeword on the shared uplink band. The resource utilization may be improved.

According to a second aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving one or more sets of bits of a first codeword on a first resource; receiving one or more sets of bits of a second codeword on a first part of a second resource; receiving one or more sets of bits of the first codeword on a second part of the second resource; and sending feedback indicating the first codeword is decoded successfully.

In some embodiments, the method further comprises: receiving a first indication for indicating at least one of: a proportion of the second part of the second resource in the second resource, a quantity of the second part of the second resource, or a distribution of the second part of the second resource in the second resource.

In an implementation, the second part of the second resource is evenly distributed in the second resource; or, the second part of the second resource is distributed at the beginning of the second resource, at the end of the second resource, or at both the beginning and end of the second resource.

In an implementation, the second part of the second resource is used for transmitting parity bits.

In some embodiments, the method further comprises: receiving one or more sets of bits of a third codeword on a first part of a third resource; receiving one or more sets of bits of the first codeword on a second part of the third resource; and receiving one or more sets of bits of the second codeword on a third part of the third resource.

In some embodiments, a time of receiving an initial set of bits of the first codeword is earlier than a time of receiving an initial set of bits of the second codeword, and the time of receiving the initial set of bits of the second codeword is earlier than a time of receiving an initial set of bits of the third codeword; and the one or more sets of bits of the second codeword are received on the third part of the third resource after the one or more sets of bits of the first codeword are received on the second part of the third resource.

In some embodiments, a quantity of the second part of the second resource is greater than a quantity of the second part of the third resource.

In some embodiments, a proportion of the second part of the second resource in the second resource is greater than a proportion of the second part of the third resource in the third resource.

In some embodiments, the method further comprises: receiving first information, wherein the first information is used for indicating a length of the one or more sets of bits of the first codeword, a starting position of the one or more sets of bits of the first codeword on time-frequency resource, or both the length of the one or more sets of bits of the first codeword and starting position of the one or more sets of bits of the first codeword on time-frequency resource; wherein the length of the one or more sets of bits of the first codeword includes at least one of: a minimum transmission length of each of the one or more sets of bits of the first codeword, or a maximum transmission length of the one or more sets of bits of the first codeword.

In some embodiments, the length of the one or more sets of bits of the first codeword is determined based on at least one of: a large scale channel quality indicator (CQI), a previous feedback, or a modulation and coding scheme (MCS).

In some embodiments, the maximum transmission length is an integer multiple of the minimum transmission length.

In some embodiments, the receiving the one or more sets of bits of the first codeword includes: receiving the one or more sets of bits of the first codeword on first frequency domain resources.

In some embodiments, the method further comprises: receiving second information, wherein the second information includes a second indication of the first frequency domain resources.

In some embodiments, the second information includes one or more BWP index(es) and/or one or more carrier index(es).

In some embodiments, the first frequency domain resources are obtained through carrier aggregation.

In some embodiments, sending the feedback corresponding to the first codeword includes: sending the feedback corresponding to the first codeword on second frequency domain resources.

In some embodiments, the first frequency domain resources belong to FDD downlink bands, and the second frequency domain resources belong to FDD uplink bands.

In some embodiments, a duration of receiving the one or more sets of bits on the first frequency domain resources is same as a duration of a reporting window of the feedback on the second frequency domain resources.

In some embodiments, the first frequency domain resources and the second frequency domain resources are at least partially overlapped.

In some embodiments, at least part of time domain resources, at least part of frequency domain resources, or at least part of the time domain resources and frequency domain resources are reserved for transmission of the feedback corresponding to the first codeword.

In some embodiments, the method further comprises: receiving a third indication for enabling the receiving of the one or more sets of bits of the first codeword on the first resource, the receiving of the one or more sets of bits of the second codeword on the first part of a second resource, and the receiving of the one or more sets of bits of the first codeword on the second part of the second resource.

In some embodiments, the sending the feedback indicating the first codeword is decoded successfully includes: sending the feedback corresponding to the first codeword at one or more feedback opportunities, and the one or more feedback opportunities are periodic.

In some embodiments, the first information is carried in Radio Resource Control (RRC) signaling or Downlink Control Information (DCI).

In some embodiments, the method further comprises: sending second feedback corresponding to the second codeword on the second frequency domain resources.

According to a third aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving one or more sets of bits of a first codeword on a first resource; receiving one or more sets of bits of the first codeword on a second part of the second resource; sending feedback indicating the first codeword is decoded successfully.

In some embodiments, the method further comprises: receiving a first indication for indicating at least one of: a proportion of the second part of the second resource in the second resource, a quantity of the second part of the second resource, or a distribution of the second part of the second resource in the second resource.

In some embodiments, the second part of the second resource is evenly distributed in the second resource; or, the second part of the second resource is distributed at the beginning of the second resource, at the end of the second resource, or at both the beginning and end of the second resource.

In some embodiments, the second part of the second resource is used for transmitting parity bits.

In some embodiments, the method further comprises: receiving one or more sets of bits of the first codeword on a second part of the third resource.

In some embodiments, a quantity of the second part of the second resource is greater than a quantity of the second part of the third resource.

In some embodiments, a proportion of the second part of the second resource in the second resource is greater than a proportion of the second part of the third resource in the third resource.

In some embodiments, the method further comprises: receiving first information, wherein the first information is used for indicating a length of the one or more sets of bits of the first codeword, a starting position of the one or more sets of bits of the first codeword on time-frequency resource, or both the length of the one or more sets of bits of the first codeword and starting position of the one or more sets of bits of the first codeword on time-frequency resource; wherein the length of the one or more sets of bits of the first codeword includes at least one of: a minimum transmission length of each of the one or more sets of bits of the first codeword, or a maximum transmission length of the one or more sets of bits of the first codeword.

In some embodiments, the length of the one or more sets of bits of the first codeword is determined based on at least one of: a large scale channel quality indicator (CQI), a previous feedback, or a modulation and coding scheme (MCS).

In some embodiments, the maximum transmission length is an integer multiple of the minimum transmission length.

In some embodiments, the receiving the one or more sets of bits of the first codeword includes: receiving the one or more sets of bits of the first codeword on first frequency domain resources.

In some embodiments, the method further comprising: receiving second information, wherein the second information includes a second indication of the first frequency domain resources.

In some embodiments, the second information includes one or more BWP index(es) or one or more carrier index(es).

In some embodiments, the first frequency domain resources are obtained through carrier aggregation.

In some embodiments, the sending the feedback indicating the first codeword is decoded successfully includes: sending the feedback corresponding on second frequency domain resources.

In some embodiments, the first frequency domain resources belong to FDD downlink bands, and the second frequency domain resources belong to FDD uplink bands.

In some embodiments, a duration of receiving the one or more sets of bits on the first frequency domain resources is same as a duration of a reporting window of the feedback on the second frequency domain resources.

In some embodiments, the first frequency domain resources and the second frequency domain resources are at least partially overlapped.

In some embodiments, at least part of time domain resources, at least part of frequency domain resources, or at least part of the time domain resources and frequency domain resources are reserved for transmission of the feedback corresponding to the first codeword.

In some embodiments, the method further comprises: receiving a third indication for enabling the receiving of the one or more sets of bits of the first codeword on the first resource, and the receiving of the one or more sets of bits of the first codeword on the second part of the second resource.

In some embodiments, the sending the feedback indicating the first codeword is decoded successfully includes: sending the feedback corresponding to the first codeword at one or more feedback opportunities, and the one or more feedback opportunities are periodic.

In some embodiments, the first information is carried in Radio Resource Control (RRC) signaling or Downlink Control Information (DCI).

According to a fourth aspect, an apparatus is provided. The apparatus comprises at least one processor configured to cause the apparatus to perform the method for data transmission in the first aspect, the second aspect, or the third aspect, or any possible implementation of the first aspect or the second aspect, or the third aspect.

According to a fifth aspect, a computer-readable medium is provided. The computer-readable storage medium has stored thereon computer program instructions that, when executed by a processing circuit of a computer, cause the computer to implement the method for data transmission in the first aspect, the second aspect, or the third aspect, or any possible implementation of the first aspect or the second aspect, or the third aspect.

According to a sixth aspect, a computer program product is provided. The computer program product has instructions that, when executed by a computer, cause the computer to implement the method for data transmission in the first aspect, the second aspect, or the third aspect, or any possible implementation of the first aspect or the second aspect, or the third aspect.

According to a seventh aspect, a system is provided. The system comprises: a first apparatus for implementing the method for data transmission in the first aspect or any possible implementation of the first aspect, and a second apparatus for implementing the method for data transmission in the second aspect or the third aspect, or any possible implementation of the second aspect or the third aspect.

The advantages brought by any design from the second to seventh aspects can be referred to the first aspect or the different designs of the first aspect, which will not be detailed here.

On the basis of the implementations provided in the above aspects, the present disclosure is able to provide more implementations by further combination.

### BRIEF DESCRIPTION OF THE DRAWINGS

FIG. 1 shows a communication system in which embodiments of the present disclosure may be implemented;

FIGS. 2A and 2B each show another communication system in which embodiments of the present disclosure may be implemented;

FIG. 3 shows an apparatus that wirelessly communicates with at least one apparatus in a communication system in accordance with some embodiments of the present disclosure;

FIG. 4A shows a block diagram of an electronic device or apparatus in accordance with some embodiments of the present disclosure;

FIG. 4B shows a block diagram of a sensing management function entity in accordance with some embodiments of the present disclosure;

FIG. 5A shows a schematic diagram of different redundancy versions (RVs) in the related art;

FIG. 5B shows an example feedback mechanism in the related art;

FIG. 6 is a schematic diagram of a method for data transmission in accordance with some embodiments of the present disclosure;

FIG. 7 shows a signaling chart of a method for data transmission in accordance with some embodiments of the present disclosure;

FIGS. 8A and 8B are schematic diagrams of a method for data transmission in accordance with some embodiments of the present disclosure;

FIG. 9 is another schematic diagram of a method for data transmission in accordance with some embodiments of the present disclosure;

FIG. 10 is yet another schematic diagram of a method for data transmission in accordance with some embodiments of the present disclosure;

FIG. 11 is yet another schematic diagram of a method for data transmission in accordance with some embodiments of the present disclosure;

FIG. 12 shows an example frame structure in accordance with some embodiments of the present disclosure;

FIG. 13 shows another example frame structure in accordance with some embodiments of the present disclosure;

FIG. 14 shows yet another example frame structure in accordance with some embodiments of the present disclosure; and

FIG. 15 shows simulation results of a power saving effect in accordance with some embodiments of the present disclosure.

### DETAILED DESCRIPTION

To solve the above problems, the present disclosure provides a method for data transmission, which includes multiple solutions. The solutions can be implemented in next-generation mobile and wireless network service, cloud and edge computing service, and sensing services. The method will be particularly useful for automated manufacturing systems in smart factories. It applies to other intelligent vertical scenarios such as ports, delivery systems and medical systems.

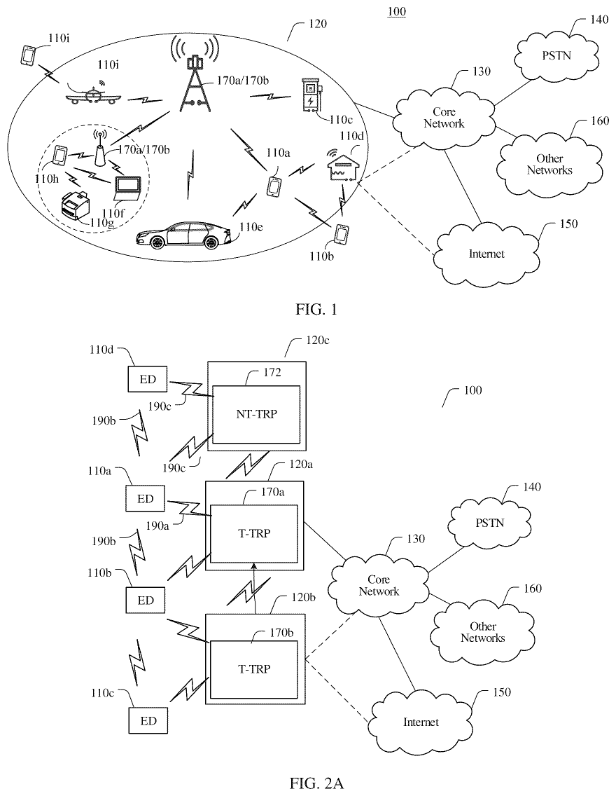

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

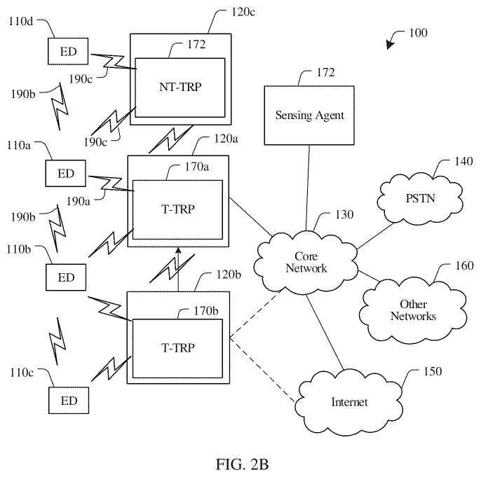

FIG. 2A illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

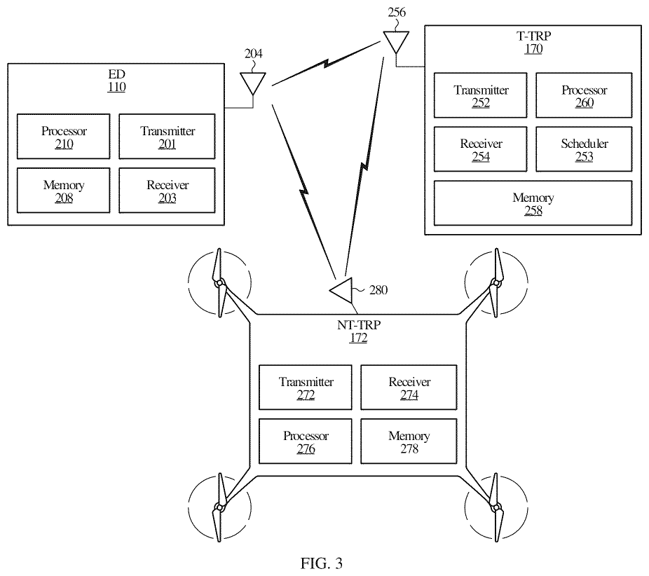

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In different systems, the CU (or the CU-CP and the CU-UP), the DU, or the RU may also have different names, but a person skilled in the art may understand meanings thereof. For example, in an ORAN system, a CU may also be referred to as an open CU (O-CU), a DU may also be referred to as an open DU (O-DU), and a CU-CP may also be referred to as an open CU-CP (O-CU-CP). The CU-UP may also be referred to as an open CU-UP (O-CU-UP), and the RU may also be referred to as an open RU (O-RU).

Any one of the CU (or the CU-CP, the CU-UP), the DU, and the RU may be implemented by using a software module, a hardware module, or a combination of a software module and a hardware module.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

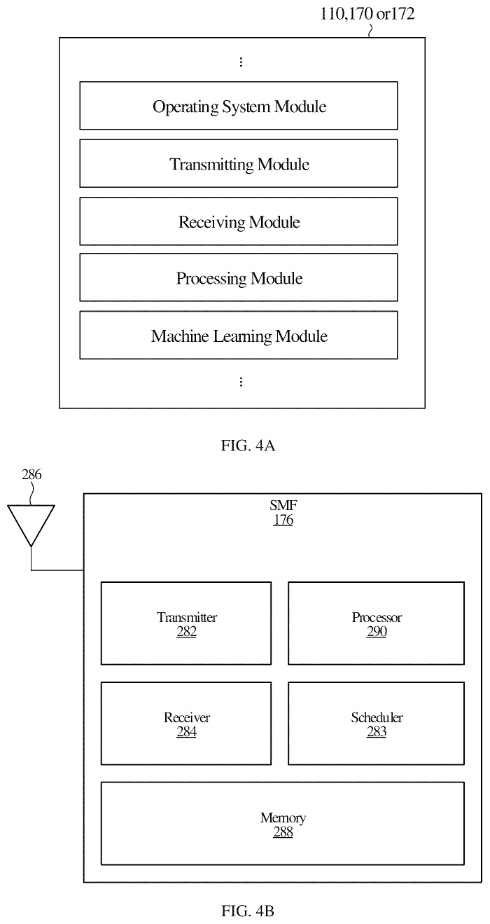

One or more steps of the embodiment methods provided herein may be performed by corresponding units or modules, according to FIG. 4A. FIG. 4A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### 6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept.” For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.

(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. mulit-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Timing Reference Point

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 (am example of ED 110) to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, At. It may be shown that the relative timing indication, At, expresses the timing reference point as occurring a particular duration, i.e., At, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

### 6G Integrated Sensing and Communication

### Generic Background

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems

### Sensing Node, Sensing Management Function

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2B, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

As shown in FIG. 4B, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

### Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### Radar

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### Half-Duplex and Full-Duplex

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp,” orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear

$$f - {f}_{c h irp 0} = α ( t - {t}_{c h irp 0} ) , where α = \frac{{f}_{chirp 1} - {f}_{c h i rp0}}{{t}_{chirp 1} - {t}_{c h irp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

### Precoding

Precoding as used herein may refer to any coding operation(s) or modulation(s) that transform a [ . . . ] input signal into a [ . . . ] output signal. Precoding may be performed in different domains, and typically transform the input signal in a first domain to an output signal in a second domain. Precoding may include linear operations.

### 6G Integrated TN & NTN

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### 6G MIMO

Multiple input multiple-output (MIMO) technology allows an antenna array of multiple antennas to perform signal transmissions and receptions to meet high transmission rate requirement. The above ED 110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and a ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

### 6G AI/ML

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtain the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI)s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

### Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

### Federated Learning:

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface.” In some embodiments, there may be two types of AI operation in an AI enabled air interface: both the network and the UE implement learning; or learning is only applied by the network.

With the current technology, there are several schemes to save transmission energy, improve spectral efficiency and enhance SINR. The first scheme is link adaptation and Hybrid automatic repeat request (hybrid ARQ or HARQ), and the second scheme is power adaptation.

HARQ is a combination of high-rate forward error correction (FEC) and automatic repeat request (ARQ). If the initial transmission fails, a retransmission is automatically requested until the successful decoding of the packet. The retransmission is conducted upon request, and is scheduled by a base station (BS).

For data channel, the BS will schedule a modulation and coding scheme (MCS) such that the target BLER is around 0.1, which means one out of ten code blocks (CB) will have decode error. In case of an error, a retransmission request is sent via the negative acknowledgement (NACK) signal.

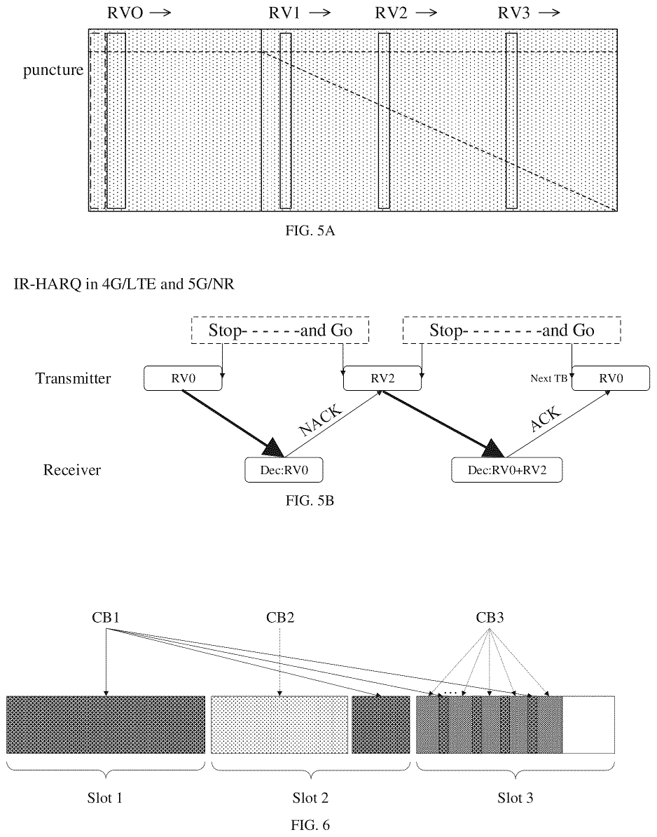

In 4G and 5G, the HARQ mechanism is also called the “stop-and-go” paradigm, where the transmitter will stop transmitting a certain packet at some point, and wait for the ACK/NACK feedback. Depending on the feedback, the transmitter may retransmit a part of the current packet, or transmit a new packet. The part of a packet is called a redundancy version (RV). For 5G LDPC, there are all four RVs (i.e., RV0, RV1, RV2, and RV3), defined by their starting positions in the base graph, shown in FIG. 5A.

As shown in FIG. 5B, the transmitter transmits RV0 of a Transport Block (TB), and then stops transmitting and waits for a corresponding feedback (e.g., ACK/NACK). After receiving RV0, the receiver decodes RV0. In a case where RV0 is not decoded successfully, the receiver feeds back a NACK to the transmitter. After receiving the NACK, the transmitter (e.g., the BS) will find a next vacant time-frequency resource block to transmit/retransmit a redundancy version (e.g., RV2) corresponding to the initial transmission (e.g., the TB). After transmitting RV2, the transmitter stops transmitting and waits for a corresponding feedback (e.g., ACK/NACK). After receiving RV2, the receiver (e.g., the UE) will combine the two transmissions and re-decode that packet (e.g., RV0 and RV2), which will typically lead to a greater-than-3 dB gain. In a case where the packet is decoded successfully, the receiver feeds back an ACK to the transmitter. After receiving the ACK, the transmitter stops transmitting the TB, and starts transmitting RV0 of a next TB.

However, the link adaptation and HARQ methods suffers from two drawbacks.

The first drawback is that Channel Quality Indicator (CQI) estimation error will lead to too aggressive or too conservative Modulation and Coding Scheme (MCS) selection. The former-too aggressive-will result in high decoding error and frequent request of retransmissions, which means excessive latency. The latter-too conservative-will result in a waste of channel resource and thus low spectrum efficiency, which means low throughput.

The second drawback is that the “stop-and-go” paradigm incurs significant extra delay compared to one-shot transmission.

As for power adaptation, due to channel (CQI) estimation error and unpredictable interference from neighboring cells and devices, the perceived SINR may be insufficient for reliable communications. In these cases, an effective method is to ramp up transmit power, until the packet is successfully decoded.

However, the power adaptation method suffers from the following drawback.

The abuse of power ramp-up actions will lead to even higher inter-cell/inter-UE interference, thus reducing the overall system energy efficiency. In the case of poor interference alignment, the excessive interference may even bring down the average perceived SINR.

There are disadvantages of the current link adaptation, HARQ and power adaption, which are mainly (i) longer latency, (ii) lower spectrum efficiency and (iii) lower power efficiency.

These problems cannot be solved within the current technical framework, but require a fundamentally different transmission and link control strategy. In short, we need propose schemes to address the abovementioned three problems, i.e., reduce latency, improve spectrum efficiency and power efficiency all at once.

To solve the above problems, the present disclosure provides a method for data transmission. The proposed method is puncture and repeat without request (PROQ), an arrive-and-go transmission framework. Unlike the stop-and-go paradigm, the arrive-and-go paradigm does not wait for any ACK/NACK and keeps transmitting until successful reception (decoding). In such a case, a code block (CB) is further segmented into many smaller RVs (i.e., short RVs), and these RVs are discontinuously transmitted. Some parts of the RVs (i.e., some of the RVs) are transmitted in a slot, while others may be transmitted in other slots by puncturing other transmissions. In addition, the UE may not have to wait for scheduling, and a retransmission request is not necessary required between these RVs. When transmitting multiple short RVs in a single scheduled transmission, the NACK may not need to be fed back, and a 1-bit ACK is fed back upon successful decoding. As long as an ACK is not received, the remaining part of the RVs will be opportunistically transmitted in subsequent slots. If a packet is not successfully decoded after a slot, the remaining RVs will be automatically and opportunistically transmitted in subsequent slots, where a primary transmission is early terminated due to successful decoding.

FIG. 6 is a schematic diagram of a method for data transmission in accordance with some embodiments of the present disclosure. CB1 is transmitted on Slot 1 and is bounded by the slot boundary of Slot 1. Since CB1 is not successfully decoded after a slot (e.g., Slot 1), the remaining RVs of CB1 (simply put, CB1) will be automatically and opportunistically transmitted in subsequent slots (Slot 2 and/or Slot 3). As shown in FIG. 6, CB2 is transmitted on Slot 2 and is punctured (e.g., reverse-order punctured) by CB1 (e.g., RVs of CB1). In addition, transmission of CB1 on Slot 2 is also bounded by the slot boundary of Slot 2. Since CB1 is still not successfully decoded at the end of Slot 2, the remaining RVs of CB1 (simply put, CB1) may be transmitted on Slot 3. As shown in FIG. 6, CB3 is transmitted on Slot 3 and is punctured (e.g., evenly punctured) by CB1.

In another case, if CB1 in FIG. 6 is decoded successfully before the end of Slot 1, transmission of CB1 may be early terminated and may not occupy the whole Slot 1.

To support the above PROQ scheme, the standard and protocol needs to be modified in multiple places:
A channel code that supports multi-RV and corresponding RV design;
Cross-slot CB-to-resource mapping;
Punctured ratio in a slot and discontinuous punctured patterns;
Control signaling to manage the new PROQ mode;
Association between data packet and feedback.

The advantages of the present disclosure are four-fold: save transmitting energy; reduce inter-cell and inter-UE interference; no need for accurate CQI measurement and feedback; less ACK/NACK feedback.

Real-time acknowledgement amid transmissions (RAAT) scheme provides an arrive-and-go transmission framework. Unlike the stop-and-go paradigm, the arrive-and-go paradigm does not wait for any ACK/NACK and keep transmitting until successful reception (decoding). In other words, the transmitting device, adopting the arrive-and-go paradigm does not wait for any feedbacks (e.g., ACK/NACK), keeps transmitting until the receiving device achieves a successful decoding. In such a case, a code block (CB) is further segmented into many smaller RVs (i.e., short RVs), and these RVs are consecutively transmitted. Many detailed designs are identical to the RAAT scheme, and are not repeated here. The differences are mainly (i) an undecoded TB has to stop at some point and release the resource to the next TB; (ii) the incremental redundancy bits of an undecoded TB can be transmitted in subsequent slots by puncturing incumbent TBs.

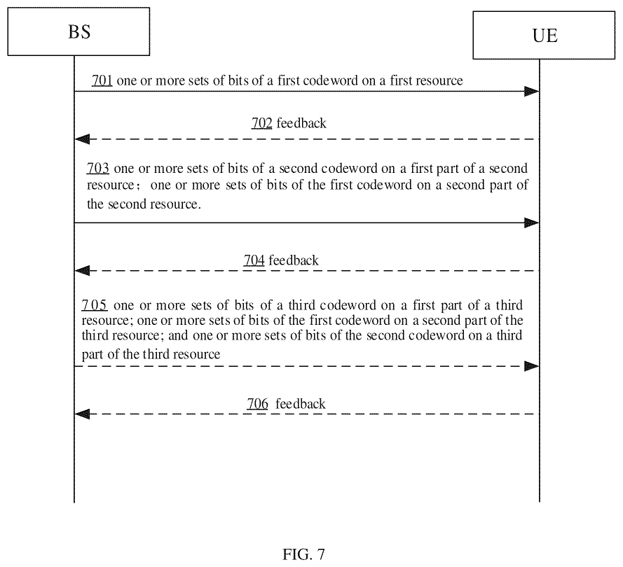

Various embodiments of the present disclosure will be described below by way of example. The following embodiments will be illustrated by taking an example where the transmitting device is a BS and the receiving device is a UE. Reference is now made to FIG. 7, which shows a signaling chart of a method for data transmission in accordance with some embodiments of the present disclosure. The signaling chart involves the BS and the UE.

In step 701, the BS sends one or more sets of bits of a first codeword on a first resource to the UE. Accordingly, the UE receives one or more sets of bits of a first codeword.

A set of bits may also be referred to as an RV. In such case, in step 701, the BS may send one or more RVs of the first codeword on a first resource to the UE. Accordingly, the UE may receive one or more RVs of the first codeword. Note that RV(s) are not necessarily aligned with channel resources (e.g., slots, symbols).

The first resource may be a time resource (e.g., a slot, a mini-slot, or a virtual TTI), a frequency resource, or a time-frequency resource, which is not limited in the present disclosure. A virtual TTI may be shorter than the TTI in the related art, which is not limited here.

Note that a codeword may be a TB, a Code Block Group (CBG), or a Code Block (CB), which is not limited in the present disclosure.

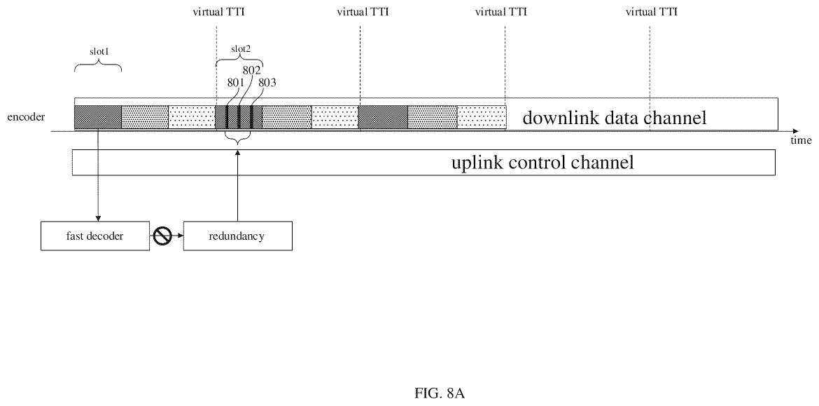

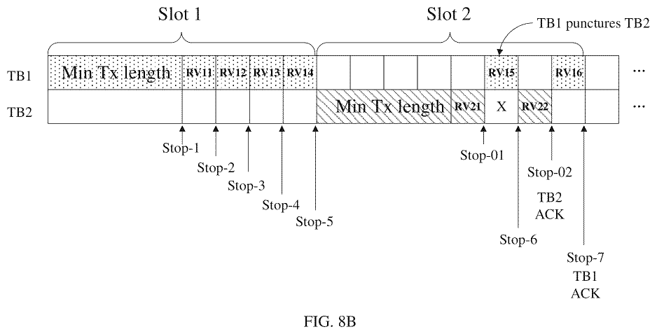

In some embodiments, as shown in FIG. 8A, the present disclosure involves a downlink data channel and an uplink control channel. The data transmission in the downlink data channel may be scheduled in a certain slot (virtual TTI, which is a time unit used for data transmission). After encoding the data, the encoder (e.g., the BS) sends RV(s) of a first codeword to the decoder (e.g., the UE). The decoder may also be referred to as a fast decoder. Once the UE begins to receive the RV(s) of the first codeword from the BS, the UE as a decoder performs decoding while receiving the RV(s) of the CB.

In an implementation, the UE may start decoding an RV upon receiving the RV from the BS.

In another implementation, before step 701, the BS may send first information to the UE in step 700. Accordingly, the UE may receive the first information from the BS. Step 700 is optional.

In step 700, the BS sends first information to the first terminal device, the first information is used for indicating a length of the one or more sets of bits of the first codeword and/or a starting position of the one or more sets of bits of the first codeword on time-frequency resource. The length of the one or more sets of bits of the first codeword includes at least one of: a minimum transmission length of each of the one or more sets of bits of the first codeword, or a maximum transmission length of the one or more sets of bits of the first codeword.

In some embodiments, the first information may be configuration information. The configuration information may indicate a total length (e.g., minimum transmission length and/or maximum transmission length) of RVs (one or more sets of bits) of a codeword and/or a starting position of an initial RV (one set of bits) of the codeword on time-frequency resource. The length may be represented by a certain number of bits, a certain number of symbols, or a certain duration of time (e.g., a few seconds/milliseconds/nanoseconds). The starting position refers to time or symbol at which the RV starts to be transmitted. The starting position may be a slot or a symbol index.

In this case, the BS may schedule transmission by configuring the starting position, minimum transmission length and/or maximum transmission length of the first codeword. Thus, the UE may perform decoding according to the configuration information.

The minimum transmission length is to tell the UE to at least receive such a length before performing the first decoding attempt. The minimum transmission length may be set to a length that allows for a highest success rate of decoding. The minimum transmission length may also be referred to as a minimum length, a Min Tx length, or an initial length. As an example, the minimum transmission length is 10 bits.

In an implementation, the length of RV(s) of a codeword may be determined by the BS. The length of RV(s) of a codeword may be determined based on at least one of: a large scale CQI, a previous feedback, or a modulation and coding scheme (MCS).

In some embodiments, the maximum transmission length may be set to ensure the user latency. The maximum transmission length may be a predictable jitter. For example, the maximum value of the predictable jitter is 4 TTI (e.g., the length of one time resource is 1 TTI), which means that the transmission of a codeword is limited within 4 consecutive time resources. In such case, the codeword is required to be transmitted within 4 consecutive time resources. If the codeword is not successfully decoded within 4 consecutive time resources, the remaining RVs of the codeword will no longer be transmitted by the BS.

In an implementation, the maximum transmission length is an integer multiple of the minimum transmission length.

The UE, according to configuration information, may not start decoding the RV until a certain length (e.g., a minimum transmission length) of RV(s) is received. For example, the length of an RV is 10 bits, the minimum transmission length is 20 bits, and the UE may not start decoding the RVs until it receives 20 bits (e.g., until it receives two RVs). In this way, the UE may start decoding the RVs after it receives bits with a total length longer than the minimum transmission length, which improves the possibility of the bits being successful decoded. In addition, since the UE may not start decoding the RVs until receiving RVs of a minimum transmission length from the BS, energy consumption of the UE may be reduced. The configuration information may be sent from the BS to the UE.

In step 702, the UE may send to the BS a feedback corresponding to the first codeword.

After decoding, the UE may send to the BS a feedback corresponding to the first codeword. For example, in a case where the first codeword is decoded successfully, the UE may send a positive feedback (e.g., an ACK) to the BS. In a case where the first codeword is not decoded successfully, the UE may not send a feedback to the BS to indicate decoding failure. Alternatively, in a case where the first codeword is not decoded successfully, the UE may send a negative feedback (e.g., a NACK) to the BS to indicate decoding failure, which is optional.

As shown in FIG. 8A, in a case where the BS does not receive an ACK on slot1, the BS may stop transmitting the RV(s) of the current codeword at the end of slot1.

In step 703, the BS sends one or more sets of bits of a second codeword on a first part of a second resource, and sends one or more sets of bits of the first codeword on a second part of the second resource. Accordingly, the UE receives the one or more sets of bits of the second codeword on the first part of the second resource, and receives the one or more sets of bits of the first codeword on the second part of the second resource.

In some embodiments, a PDSCH may stop transmission at the end of a slot (or multi-slot, or any allocated resource). If the PDSCH decoding failed in its own slot (resource), it may use other PDSCH's slot by puncturing certain symbols.

In the example shown in FIG. 8A, the first codeword is transmitted by the BS and received by the UE on slot1, which is an example of the first resource. However, the first codeword is not decoded successfully by the UE at the end of slot1. In such case, the UE may not send an ACK corresponding to the first codeword to the BS. The BS may stop transmitting RVs of the first codeword at the end of slot1, and may start sending RVs of the second codeword on a slot after slot1 (e.g., slot2, which is an example of the second resource). Since the ACK corresponding to the first codeword is not received by the BS, the remaining RVs of the first codeword will be opportunistically transmitted on the slot after slot1.

As shown in FIG. 8A, the BS sends RV(s) of the second codeword on the first part of the second resource. Specifically, the BS sends the RV(s) of the second codeword on the resources of slot2 other than resources 801, 802, and 803. In addition, the BS sends redundancy bits (e.g., RV(s)) of the first codeword on a second part of the second resource. Specifically, the BS sends the RV(s) of the first codeword on resources 801, 802, and 803.

As described above, transmission of the codeword is bounded by the slot boundaries. In this way, transmission of the current codeword may not affect the start of transmission of the next codeword. In addition, if the first codeword is not successfully decoded in a slot, the remaining RVs of the first codeword will be automatically and opportunistically transmitted in subsequent slots (e.g., slot2). In this way, the current codeword may be decoded successfully.

Note that the first codeword and the second codeword may be transmitted to the same UE or different UEs. For example, the first codeword may be sent to a first terminal device, and/or the second codeword may be sent to a second terminal device.

There may be PROQ processes instead of HARQ processors to track different TB/CBs. PROQ process may be identified by process ID. HARQ (or PROQ) process ID can be maintained, and undecoded TB shall be buffered.

Moreover, the PROQ scheme is backward compatible and may co-exist with the legacy HARQ scheme. Therefore, there may be signaling to indicate HARQ mode or PROQ mode, or RAAT mode. For example, the BS may indicate to the UE whether to adopt HARQ mode or RAAT mode or PROQ mode via a field in RRC or DCI signaling. If the BS indicates that the PROQ mode is to be adopted, the BS and the UE may perform the steps 701 to 706. If the BS indicates that the conventional HARQ mode is to be adopted, the BS and the UE may perform the steps of the HARQ scheme in the related art.

In some embodiments, the UE may not start decoding the RVs until it receives bits of a minimum transmission length. The minimum transmission length is to tell the UE to at least receive such a length before performing the first decoding attempt. The minimum transmission length may be set to a length that allows for a highest success rate of decoding. The minimum transmission length may also be referred to as a minimum length, a Min Tx length, or an initial length. As an example, the minimum length is 10 bits.

The minimum transmission length of RV(s) of a codeword may be determined based on at least one of: a large scale CQI, a previous feedback, or a modulation and coding scheme (MCS).

In an implementation, the minimum transmission length may be determined based on the large scale CQI. Since the length of the RV(s) of the CB are not fixed in the present disclosure, there is no need to obtain a real-time accurate CQI to determine the transmission length. For example, the UE measures CQI-RS and reports CQI (e.g., large scale CQI) to the BS. After receiving the CQI, the BS determines the minimum transmission length based on the large scale CQI, and the BS informs the UE of the minimum transmission length. The large scale CQI may also be referred to as open-loop CQI. For example, the large scale CQI may be an average CQI over a certain period of time.

In an implementation, the minimum transmission length may be determined based on the previous positive feedback(s). The previous positive feedback(s) refers to previously received ACK(s), and the previous positive feedback(s) may reflect the time or frequency at which the BS receives ACK(s). The previous positive feedback(s) may also be referred to as ACK instance(s).

In an implementation, the minimum transmission length may be determined based on the MCS.

In an implementation, a scheduling algorithm of the BS takes the open-loop CQI, ACK (i.e., ACK instance), and the current scheduled modulation and coding rate as input, and outputs a minimum transmission length.

Compared to legacy HARQ, very aggressive MCS selection based on little or inaccurate CQI information is needed in the present disclosure.

In an example where a codeword is a TB, as shown in FIG. 8B, it is arranged that there are no feedback opportunities until a Min Tx length of TB1/TB2 is transmitted. In this way, the UE will not start decoding until it receives the Min Tx length of bits (e.g., 20 bits) of TB1. Each RV (e.g., RV11, RV12, RV13, and RV14) of TB1 after the Min Tx length of TB1 corresponds to a feedback opportunity (e.g., Stop-2, Stop-3, Stop-4, and Stop-5). Note that the RVs of the Min Tx length of TB1 may correspond to the feedback opportunity Stop-1.

After receiving the Min Tx length (e.g., 20 bits) of TB1, the UE, once the TB1 is successfully decoded, may feed back an ACK at a feedback opportunity immediately afterwards. The earliest time of the feedback opportunity (e.g., T_{feedback}) corresponding to the RV transmitted at time Tₜᵣₐₙₛ may satisfy: T_{feedback}=Tₜᵣₐₙₛ+Tₚᵣₒₚ+T_{proc}, where Tₚᵣₒₚ represents the channel propagation time over the air of the corresponding RV; T_{proc} represents the processing time at the UE to process and decode the RV.

As shown in FIG. 8B, TB1 has not been decoded successfully even after RV14 is transmitted and decoded. The UE may feed back NACK at Stop-1, Stop-2, Stop-3, Stop-4, or Stop5, which is optional. In addition, transmission of TB1 needs to stop at the end of Slot 1. Since decoding of TB1 failed in its own slot (i.e., Slot 1), the remaining RVs of TB1 will be opportunistically transmitted on a subsequent slot (e.g., Slot 2).

As shown in FIG. 8B, the BS starts transmitting TB2 at the beginning of Slot 2. Similarly, each RV (e.g., RV21 or RV22) of TB2 after the Min Tx length of TB2 corresponds to a feedback opportunity (Stop-01, or Stop-02). Once TB2 is successfully decoded, the UE may feed back an ACK at a feedback opportunity (Stop-02) immediately afterwards.

The remaining RVs (RV15 and RV16) of the TB1 are transmitted on Slot 2 by puncturing TB2. RV15 corresponds to the feedback opportunity Stop-6, and RV16 corresponds to the feedback opportunity Stop-7. Once TB1 is successfully decoded, the UE may feed back an ACK at a feedback opportunity immediately afterwards (Stop-7).

Compared to legacy HARQ, there are almost-zero time gap between PDSCH and ACK/NACK; much denser ACK/NACK: after receiving every symbol/mini-slot; and real-time/continuous ACK instead of asynchronous/synchronous HARQ. In addition, the cross-slot CB-to-resource mapping helps the PROQ scheme achieve more flexible and efficient channel utilization.

In step 704, the UE transmits a feedback corresponding to the first codeword, and the feedback is for indicating whether the first codeword is decoded successfully. Accordingly, the BS receives the feedback corresponding to the first codeword.

For example, when the BS transmits the RV(s) of the first codeword on slot2 in FIG. 8A, the UE performs decoding while receiving the RV(s) of the first codeword. In a case where the first codeword is decoded successfully by the UE, the UE may send a positive feedback to the BS.

In some embodiments, the UE may transmit a NACK to the BS in a case where the codeword is not decoded successfully, which is optional.

As described above, the UE may feed back ACK but may not feed back NACK. In such case, the UE may determine or generate a codebook including ACK but not including NACK, and the UE may transmit the codebook to the BS. For example, according to the proposed HARQ codebook (i.e., PROQ codebook), the UE may only transmit ACK per CB/CBG, but may not transmit NACK.

The feedback may be transmitted by the UE according to feedback opportunities. Feedback opportunities refers to possible time instants/transmission positions for UCI reports transmitted on PUCCH and PUSCH channels. For example, a feedback opportunity refers to a possible transmission time/transmission position for a UE feedback (e.g., ACK/NACK). The one or more feedback opportunities may be referred to as transmission granularity (i.e., Tx granularity) and/or feedback granularity (e.g., ACK/NACK granularity).

In some embodiments, the one or more feedback opportunities may be periodic. In such case, time gap between two contiguous feedback opportunities may be configured by the BS or may be pre-configured. The UE may transmit feedbacks to the BS periodically at the feedback opportunities. For example, as shown in FIG. 8B, the time gap (e.g., time gap 1) between “Stop-1,” “Stop-2,” “Stop-3,” “Stop-4,” and “Stop-5” is the same. One or more feedback opportunities for the feedback may be periodic. The positions and number of the one or more feedback opportunities may be the same at each period.

In an implementation, the one or more feedback opportunities may be configured (e.g., configured altogether but not separately) before the RVs are transmitted from the BS to the UE. For example, the BS may configure the period of a plurality of feedback opportunities. In such case, when the UE is to transmit feedbacks to the BS, the UE may not need to wait for scheduling of each feedback since the period of the feedback opportunities is already configured. Therefore, the UE may transmit the feedbacks in a timely manner.

In some embodiments, the one or more feedback opportunities may be aperiodic. For example, the one or more feedback opportunities may be scheduled by the BS on demand, and the one or more feedback opportunities may be scheduled separately. In such case, the BS may schedule the one or more feedback opportunities while the BS is transmitting RV(s) to the UE.

The first information may be carried in Radio Resource Control (RRC) signaling. In this case, the parameters (Tx/ACK/NACK granularity) may be carried in RRC signaling. For example, the time gap between two feedbacks may be configured in RRC configurations. In an implementation, the time gap between two feedbacks may be indicated by PUCCH-Config. In another implementation, the time gap between two feedbacks may be indicated by configured grant-uplink control information (CG-UCI).

In RRC configurations, there may be a field to describe the time gap between two feedbacks. The field may be called

PUCCH-Config::{
multi-ACK-timeGap SEQUENCE (SIZE (1..maxNofGap)) OF PUCCH-multiACK-timeGap
}
or
CG-UCI::{
multi-ACK-timeGap SEQUENCE (SIZE (1..maxNofGap)) OF multiACK-timeGap
}

In some embodiments, in DCI configuration, an indication (e.g., “HARQ multi-ACK_NACK flag”) may be used to indicate whether PROQ is enabled or disabled. In an implementation, 1 bit is used to indicate whether PROQ is enabled or disabled. For example, “0” (e.g., HARQ multi-ACK_NACK flag=0) indicates multi-ACK feedback is disabled, and “1” (e.g., HARQ multi-ACK_NACK flag=1) indicates multi-ACK feedback is enabled.

After the UE receives the indication, the UE may perform feedback accordingly. In a case where the UE detects {HARQ multi-ACK_NACK flag=0}, then the UE may perform conventional HARQ feedback. In a case where the UE detects {HARQ multi-ACK_NACK flag=1}, then the UE may perform feedback according to the PROQ scheme. In the latter case, the UE may obtain the time gap between two feedbacks according to the RRC configuration, and may report multiple feedbacks accordingly at the feedback opportunities (e.g., in allocated symbols/mini-slots).

In another implementation, a plurality of bits is used to indicate whether multi-ACK feedback is enabled or disabled. For example, 4 bits is used to indicate whether multi-ACK feedback is enabled or disabled. All zeros indicate disable and other values indicate the additional number of feedbacks apart from one feedback to be reported. “0000” indicates multi-ACK feedback is disabled and there is one feedback opportunity corresponding to one RV; “0001” indicates multi-ACK feedback is enabled and there is two feedback opportunities corresponding to one RV; “0010” indicates multi-ACK feedback is enabled and there is three feedback opportunities corresponding to one RV; . . . “1111” indicates multi-ACK feedback is enabled and there is sixteen feedback opportunities corresponding to one RV.

As an optional design, the BS may add a margin to an RV to determine an actual transmission length of an RV and the corresponding feedback opportunity. The margin may be additional transmission length/duration/time for an RV. In an implementation. A simplest example is to record required transmission time in history and add a margin to it if necessary. For example, an RV (e.g., RV₁₀₀₀) of 1000 bits is to be transmitted. According to history statistics, 1000 bits lead to 10% error probability, then a margin of 100 bits may be added to RV₁₀₀₀. In such case, the actual transmission length of RV₁₀₀₀ is 1100 bits, and RV₁₀₀₀ becomes RV₁₁₀₀ which contains 1100 bits. Accordingly, the feedback opportunity corresponding to RV₁₀₀₀ is at the time when 1100 bits (i.e., 1100 bits of RV₁₁₀₀) is transmitted.

As an example, the margin may be determined by transmission time and/or decoding time. Or, the margin may be determined by other parameters. Or, the margin may be pre-configured.

As an example, the BS may indicate the margin to the UE.

The BS may stop sending the one or more sets of bits of the first codeword in a case where the first codeword is decoded successfully. Upon receiving feedback indicating the first codeword is decoded successfully, the BS may terminate the sending of the one or more sets of bits of the first codeword in response to the feedback.

For example, the BS may stop transmitting the RV(s) of the first codeword once it receives an ACK indicating that the first codeword is decoded successfully by the UE.

In some embodiments, the first codeword may be decoded successfully in a relatively short period of time. For example, the transmission of the first codeword occupies only a part of a slot instead of the whole slot. In this case, transmission of the first codeword may be early terminated due to successful decoding, and transmission of the first codeword may not occupy a whole slot.

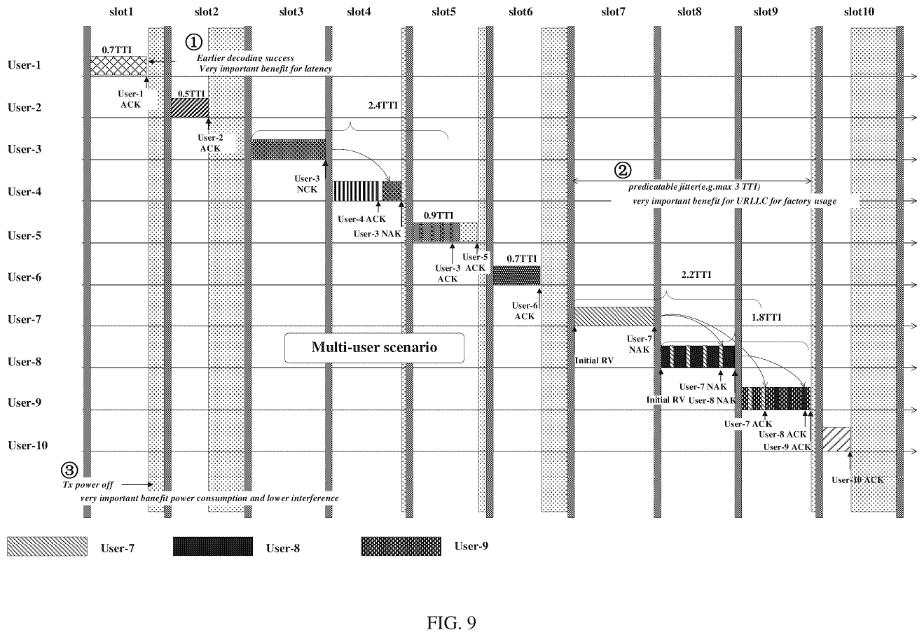

The puncturing design provides a good way to mitigate and align interference among different UEs from different cells. In the multi-cell multi-user scenarios, an early terminated transmission will not only save energy and reduce cross-interference, but also provide time/frequency resource for other UEs to transmit remaining RVs. Such a scenario is illustrated in FIG. 9.

Reference is now made to FIG. 9, which shows a multi-user scenario (each user refers to a UE). As shown in FIG. 9, once the codeword of User-1 is decoded successfully by User-1, User-1 transmits an ACK to the BS. Once receiving the ACK from User-1, the BS knows that the codeword of User-1 is decoded successfully by User-1. Accordingly, the BS stops transmitting the codeword of User-1. In such case, transmission of the codeword of User-1 occupies 0.7 TTI. There is an early decoding success for the codeword of User-1. Upon received an ACK, the BS immediately stops transmitting the current TB/CBs (e.g., the codeword of User-1), and wait until the next slot to schedule/transmit the next TB/CB (e.g., the codeword of User-2). In other words, transmission of the next TB/CB may need to wait for new slot.

Since User-1 does not have to wait until the end of slot1 to transmit the ACK, the User-1 may transmit the ACK immediately after it decodes the codeword of User-1 successfully, which brings very important benefit for user latency. “Tx power off” means that the BS stops transmitting the codeword once it is decoded successfully, which brings very important benefit for power consumption and lower interference.

Similarly, User-2 transmits an ACK to the BS once the codeword of User-2 is decoded successfully by User-2, and transmission of the codeword of User-2 occupies 0.5 TTI; User-6 transmits an ACK to the BS once the codeword of User-6 is decoded successfully by User-6, and transmission of the codeword of User-6 occupies 0.7 TTI; User-10 transmits an ACK to the BS once the codeword of User-10 is decoded successfully by User-10, and transmission of the codeword of User-10 does not occupy a whole TTI.

As shown in FIG. 9, codeword of User-3 is transmitted on slot3. The BS starts transmitting the codeword of User-3 at the beginning of slot3. User-3 performs decoding while receiving the codeword of User-3. However, the codeword of User-3 is not decoded successfully at the end of slot3. In such case, User-3 may transmit a negative feedback (e.g., NACK or NAK) to the BS. Note that User-3 may not transmit a feedback to the BS in the case where the codeword of User-3 is not decoded successfully.

The BS stops transmitting the codeword of User-3 at the end of slot3 and starts transmitting the codeword of User-4 at the beginning of slot4. Once the codeword of User-4 is decoded successfully by User-4, User-4 transmits an ACK to the BS. Once receiving the ACK from User-4, the BS knows that the codeword of User-4 is decoded successfully by User-4. Accordingly, the BS stops transmitting the codeword of User-4. As shown in FIG. 9, transmission of the codeword of User-4 does not occupy a whole slot4. Since transmission of the codeword of User-4 occupies only a part of slot4, the remaining part of slot4 may be used for transmission of other codewords.

As described above, the codeword of User-3 is not decoded successfully at the end of slot3. As long as an ACK corresponding to the codeword of User-3 is not received by the BS, the remaining RVs of the codeword of User-3 may be opportunistically transmitted in subsequent slots. As shown in FIG. 9, the remaining RVs of the codeword of User-3 are transmitted on the remaining part of slot4. However, the codeword of User-3 is not decoded successfully at the end of slot4. In such case, User-3 may transmit a negative feedback (e.g., NACK or NAK) to the BS. Note that User-3 may not transmit a feedback to the BS in the case where the codeword of User-3 is not decoded successfully.

The BS stops transmitting the codeword of User-4 at the end of slot4 and starts transmitting the codeword of User-5 at the beginning of slot5. As long as an ACK corresponding to the codeword of User-3 is not received by the BS, the remaining RVs of the codeword of User-3 may be opportunistically transmitted in subsequent slots. As shown in FIG. 9, transmission of the codeword of User-5 is punctured. In other words, the codeword of User-5 is punctured. The remaining RVs of the codeword of User-3 are transmitted on slots by puncturing the codeword of User-5. In a case where the codeword of User-3 is decoded by User-3 successfully, User-3 transmits an ACK to the BS. Once the BS receives the ACK from User-3, the BS stops transmitting the codeword of User-3, and the codeword of User-5 is no longer punctured by the codeword of User-3. In a case where the codeword of User-5 is decoded by User-5 successfully, User-5 transmits an ACK to the BS. Once the BS receives the ACK from User-5, the BS stops transmitting the codeword of User-5. As shown in FIG. 9, it takes 0.9 TTI to transmit the entire codeword of User-5, due to intermissions.

In another example shown in FIG. 9, the codeword of User-7 is transmitted on slot7. The BS stops transmitting the codeword of User-7 at the end of slot7 and starts transmitting the codeword of User-8 at the beginning of slot8. However, the codeword of User-7 is not decoded successfully at the end of slot7. In such case, User-7 may transmit a negative feedback (e.g., NACK or NAK) to the BS, which is optional.

In a case where an ACK corresponding to the codeword of User-7 is not received by the BS, the remaining RVs of the codeword of User-7 may be opportunistically transmitted in subsequent slots. As shown in FIG. 9, the remaining RVs of the codeword of User-7 are transmitted on slot8 by puncturing transmission of the codeword of User-8 (i.e., by puncturing the codeword of User-8). However, the codeword of User-7 is still not decoded successfully by User-7 at the end of slot8. In such case, User-7 may not transmit a feedback or may transmit a negative feedback (e.g., NACK or NAK) to the BS.

In some embodiments, TTI may be a time slot.

Optionally, the method may also involve the steps 705 and 706 described below.

In step 705, the BS sends one or more sets of bits of a third codeword on a first part of a third resource. In addition, the BS sends one or more sets of bits of the first codeword on a second part of the third resource, and sends one or more sets of bits of the second codeword on a third part of the third resource.

In the following examples, the third resource refers to slot9 in FIG. 9. With reference to the transmission of codewords of User-7, User-8, and User-9 shown in FIG. 9, the BS starts transmitting the first codeword (e.g., codeword of User-7), the second codeword, and the third codeword at the beginning of slot7, slot8, and slot9, respectively. User-7, User-8, and User-9 perform decoding while receiving the codewords.

The BS stops transmitting the codeword of User-8 at the end of slot8 and starts transmitting the codeword of User-9 at the beginning of slot9. The BS may transmit RVs of the codeword of User-9 on a first part of slot9.

As described above, the codeword of User-7 is not decoded successfully on slot7 and slot8. In such case, User-7 may not feed back an ACK to the BS. In a case where an ACK corresponding to the codeword of User-7 is not received by the BS, the remaining RVs of the codeword of User-7 may be opportunistically transmitted in subsequent slots. As shown in FIG. 9, the remaining RVs of the codeword of User-7 are transmitted on the third resource (e.g., slot9) by puncturing transmission of the codeword of User-9, which occupies a second part of slot 9.

In addition, the codeword of User-8 is not decoded successfully by User-8 during slot8. In such case, User-8 may not transmit a feedback or may transmit a negative feedback (e.g., NACK or NAK) to the BS. In a case where an ACK corresponding to the codeword of User-8 is not received by the BS, the remaining RVs of the codeword of User-8 may be opportunistically transmitted in subsequent slots. As shown in FIG. 9, the remaining RVs of the codeword of User-8 are transmitted on slot9 by puncturing transmission of the codeword of User-9 (i.e., by puncturing the codeword of User-9), which occupies a third part of slot9.

In step 706, the UE transmits a feedback corresponding to the first codeword, and the feedback is for indicating whether the first codeword is decoded successfully. Accordingly, the BS receives the feedback corresponding to the first codeword.

In the example shown in FIG. 9, the codeword of User-9 is punctured by the codeword of User-7. User-7 performs decoding while receiving the codeword of User-7 from the BS. When the codeword of User-7 is transmitted on slot9, in a case where the codeword of User-7 is decoded by User-7 successfully, User-7 transmits an ACK to the BS. Once the BS receives the ACK from User-7, the BS stops transmitting the codeword of User-7, and the codeword of User-9 is no longer punctured by the codeword of User-7. As shown in FIG. 9, it takes 2.2 TTI to transmit the entire codeword of User-7.

Likewise, as long as an ACK corresponding to the codeword of User-8 is not received by the BS, the remaining RVs of the codeword of User-8 may be opportunistically transmitted in subsequent slots. As shown in FIG. 9, the remaining RVs of the codeword of User-8 are transmitted on slot9 by puncturing transmission of the codeword of User-9. In a case where the codeword of User-8 is decoded by User-8 successfully, User-8 transmits an ACK to the BS. Once the BS receives the ACK from User-8, the BS stops transmitting the codeword of User-8, and the codeword of User-9 is no longer punctured by the codeword of User-7. As shown in FIG. 9, it takes 1.8 TTI to transmit the entire codeword of User-8.

In a case where the codeword of User-9 is decoded by User-9 successfully, User-9 transmits an ACK to the BS. Once the BS receives the ACK from User-9, the BS stops transmitting the codeword of User-9.

In some embodiments, a rule is established to decide which TB to transmit first in the punctured positions. For example, BS scheduling includes which previous PDSCH TB to retransmit in the current slot.

If multiple previous PDSCH TBs (or CBG/CB) failed to decode, a priority rule is needed to decide which TB to retransmit first. It can be some deterministic rule (for example, always retransmit the earliest undecoded TB), or dynamically scheduled by the BS.

In some embodiments, a time of sending an initial set of bits of the first codeword is earlier than a time of sending an initial set of bits of the second codeword, and the time of sending the initial set of bits of the second CB is earlier than a time of sending an initial set of bits of the third codeword. In this case, the one or more sets of bits of the second codeword are sent on the third part of the third resource after the one or more sets of bits of the first codeword are sent on the second part of the third resource.

For example, as shown in FIG. 9, the initial RV of the codeword of User-7 is transmitted at the beginning of slot7; the initial RV of the codeword of User-8 is transmitted at the beginning of slot8; and the initial RV of the codeword of User-9 is transmitted at the beginning of slot9. In such case, the time of sending the initial RV of the codeword of User-7 is earlier than the time of sending the initial RV of the codeword of User-8, and the time of sending the initial RV of the codeword of User-8 is earlier than the time of sending the initial RV of the codeword of User-9. In addition, the remaining RVs of the codeword of User-7 are transmitted on slot9 by puncturing transmission of the codeword of User-9, and the remaining RVs of the codeword of User-8 are transmitted on slot9 by puncturing transmission of the codeword of User-9. Since the time of sending the initial RV of the codeword of User-7 is earlier than the time of sending the initial RV of the codeword of User-8, the remaining RVs of the codeword of User-7 will be transmitted on slot9 earlier than the remaining RVs of the codeword of User-8 are transmitted on slot9. In other words, the remaining RVs of the codeword of User-8 will be transmitted on slot9 after the remaining RVs of the codeword of User-7 are transmitted on slot9. In this way, the remaining RVs of the earliest/oldest codeword will be prioritized.

In some embodiments, a quantity of the second part of the second resource is greater than a quantity of the second part of the third resource; and/or a proportion of the second part of the second resource in the second resource is greater than a proportion of the second part of the third resource in the third resource.

For example, as shown in FIG. 9, transmission of RV(s) of the codeword of User-7 punctures 4 mini-slots of slot8, while transmission of RV(s) of the codeword of User-7 punctures 2 mini-slots of slot9. In such case, the quantity of symbols in slot9 that are punctured for transmission of RV(s) of the codeword of User-7 is less than the quantity of symbols in slot8 that are punctured for transmission of RV(s) of the codeword of User-7. In an implementation, the proportion of symbols in slot9 that are punctured for the transmission of RV(s) of the codeword of User-7 is less than the proportion of symbols in slot8 that are punctured for the transmission of RV(s) of the codeword of User-7.

In some embodiments, a constraint or a threshold may be set to ensure the user latency. The constraint may be a predictable jitter. For example, the maximum value of the predictable jitter is 3 TTI (e.g., the length of one time resource is 1 TTI), which means that the transmission of a codeword is limited within 3 consecutive time resources. In such case, the codeword of User-7 is required to be transmitted within 3 consecutive time resources. That is, if the codeword of User-7 is not successfully decoded by User-7 at the end of slot9, the remaining RVs of the codeword of User-7 will no longer be transmitted by the BS.

In order to inform the UE of the puncture ratio or puncture pattern, the BS may send an indication to the UE, and the indication is for indicating at least one of: a proportion of the second part of the second resource in the second resource, a quantity of the second part of the second resource, or a distribution of the second part of the second resource in the second resource. Accordingly, the UE receives the indication. The proportion may also be referred to as “puncture ratio.”

In an implementation, the BS is responsible for scheduling, encoding and transmitting. However, the BS does not need to explicitly indicate the transmission of remaining RVs. The implicit time resource allocation for transmitting remaining RVs can be done in two ways: pre-defined or dynamically scheduled. In other words, the puncture ratio and patterns can be pre-defined (option 1) or dynamically scheduled (option 2).

In an implementation, the time resource allocation for transmitting remaining RVs may be pre-defined, and the pre-defined puncture radio and punctured pattern can be specified by the standard. If the current transmission is not successfully decoded in the current slot, the next slot will automatically vacate certain symbols/sub-slots for its remaining RVs.

In a case where the puncture ratio is pre-defined (option 1), the puncture ratio may be used to limit the minimum number of retransmissions (transmission of the remaining RVs) in each subsequent slot, and/or limit the maximum number of symbols for each retransmission.

The above punctured ratios can be pre-allocated in a table, see below.

TABLE 1

| | Cross-Slot puncture pattern (worst case 3 × Slot) | | | | | | |
|---|---|---|---|---|---|---|---|
| | slot1 | slot2 | slot3 | slot4 | slot5 | slot6 | . . . |
| (TB1) | 1 | 0.5 | 0.25 | | | | |
| (TB2) | | 0.5 | 0.25 | 0.25 | | | |
| (TB3) | | | 0.5 | 0.25 | 0.25 | | |
| (TB4) | | | | 0.5 | 0.25 | 0.25 | |
| . . . | | | | | . . . | . . . | . . . |

TABLE 2
Cross-Slot puncture pattern (worst case 4 × Slot)

| | | | | | | | |
|---|---|---|---|---|---|---|---|
| 1 | 0.5 | 0.25 | 0.125 | | | | |
| | 0.5 | 0.25 | 0.125 | 0.125 | | | |
| | | 0.5 | 0.25 | 0.125 | 0.125 | | |
| | | | 0.5 | 0.25 | 0.125 | 0.125 | |
| | | | | 0.5 | 0.25 | 0.125 | 0.125 |
| | | | | | . . . | . . . | . . . |

TABLE 3
Cross-Slot puncture pattern (worst case 5 × Slot)

| | | | | | | | | | |
|---|---|---|---|---|---|---|---|---|---|
| 1 | 0.5 | 0.25 | 0.125 | 0.0625 | | | | | |
| | 0.5 | 0.25 | 0.125 | 0.0625 | 0.0625 | | | | |
| | | 0.5 | 0.25 | 0.125 | 0.0625 | 0.0625 | | | |
| | | | 0.5 | 0.25 | 0.125 | 0.0625 | 0.0625 | | |
| | | | | 0.5 | 0.25 | 0.125 | 0.0625 | 0.0625 | |
| | | | | | 0.5 | 0.25 | 0.125 | 0.0625 | 0.0625 |
| | | | | | | . . . | . . . | . . . | . . . |

Some descriptions of the tables are below:

Each row represents a TB (or CBG/CB), of a user or different users—how much proportion of symbols does the TB occupy in subsequent slots?

Each column is a slot (or multi-slot)—how to allocate REs to this TB and other previous TBs?

The tables are categorized by the maximum number of slots allowed for a packet transmission. For example, if the worst case is 3 slots, then the BS will try to transmit a packet in 3 slots, and after which a decoding failure and conventional HARQ may be triggered if the decoding is still unsuccessful.

Table 1 shows an example that the worst case is 3 slots. As shown in Table 1, in the first row, “1” means that the proportion of TB1 in slot1 is 1 (i.e., 100%); “0.5” means that the proportion of TB1 in slot2 is 0.5 (i.e., 50%); “0.25” means that the proportion of TB1 in slot3 is 0.25 (25%). In other words, the whole slot1, 0.5 of slot2, and 0.25 of slot3 are allocated for transmission of TB1.

Referring to the second row of Table 1, 0.5 of slot2, 0.25 of slot3, and 0.25 of slot4 are allocated for transmission of TB2.

Referring to the third row of Table 1, 0.5 of slot3, 0.25 of slot4, and 0.25 of slots are allocated for transmission of TB3.

Referring to the fourth row of Table 1, 0.5 of slot4, 0.25 of slot5, and 0.25 of slot6 are allocated for transmission of TB4.

Note that if a previous TB is successfully decoded, the pre-allocated resource for puncturing is NOT used. For example, referring to Table 1, if TB1 is successfully decoded in slot1 (before slot2 begins), TB1 does not need to be transmitted in subsequent slots. In such case, the pre-allocated resource for puncturing (0.5 of slot2 for transmission of TB1) will not be used for transmission of TB1. The pre-allocated resource for puncturing may be idle or may be used for transmission of other TB(s).

Similarly, Table 2 shows an example where the worst case is 4 slots, and Table 3 shows an example where the worst case is 5 slots.

The puncture ratio and patterns may be indicated by signaling. In an implementation, RRC/DCI indicator may be used to indicate: puncture patterns, and/or proportion of punctured symbols in a slot.

In another implementation, retransmission resource (e.g., puncture pattern) indication may be used for indicating puncture pattern. For example, “index=0” means puncturing in a direction from the end of the second resource to the beginning of the second resource; “index=1” means puncturing in a direction from the beginning of the second resource to the end of the second resource; and “index=2” means puncturing the second resource from either direction evenly. Two bits may be used to indicate the indexes.

The UE behavior is to interpret the punctured pattern from RRC/DCI, and only decode its own TB. The UEs may transmit or keep silent on certain symbols (or REs) according to puncture patterns, which are either pre-defined or signaled by BS.

In some embodiments, the second part of the second resource is evenly distributed in the second resource; or the second part of the second resource is distributed at the beginning and/or end of the second resource.

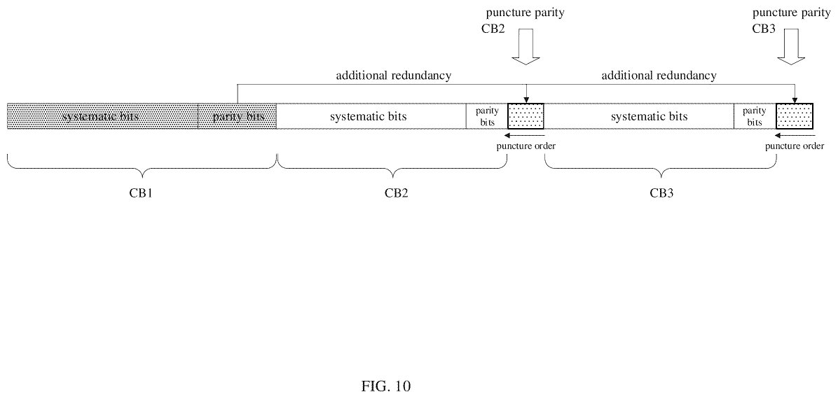

In an example, as shown in FIG. 6, RVs of CB1 are evenly distributed in CB3. In another example, as shown in FIG. 10, CB2 and CB3 are reverse-order punctured. In other words, in FIG. 10, CB2 and CB3 are punctured in a direction from the end to the beginning. In yet another example, a CB may be punctured from its beginning to its end or punctured from both ends to the middle.

In some embodiments, the second part of the second resource is used for transmitting parity bits.

As shown in FIG. 10, a CB consists of systematic bits and parity bits. RV(s) (e.g., additional redundancy) of CB1 is transmitted by puncturing CB2 and CB3. In order to reduce the influence of puncture, parity bits of a CB may be punctured while systematic bits of a CB may not be punctured. For example, the parity bits of CB2 and CB3 are punctured for transmission of CB1, and the puncture order is from the end of CB2/CB3 to the beginning of CB2/CB3. In this way, decoding of CB2/CB3 may not be influenced even if CB2/CB3 is punctured.

In another implementation, resource allocation for transmitting remaining RVs may be dynamically scheduled. For example, the ACK signal will automatically vacate all remaining symbols/sub-slots in that slot for transmitting the remaining RVs of a previous packet. If the two transmissions (packets) are from different UEs, then any ACK should be broadcast to other UEs, such that upon hearing an ACK of another UE, the UE with unfinished transmission may continue to receive its remaining RVs in these vacated symbols/sub-slots. To avoid collision among multiple UEs, some pre-defined rules to use these vacated symbols/sub-slots may be specified.

In the case where the puncture ratio is dynamically scheduled (option 2), there may be no/some limit on minimum retransmission symbols in subsequent slots; and/or no limit on maximum number of slots for retransmission.

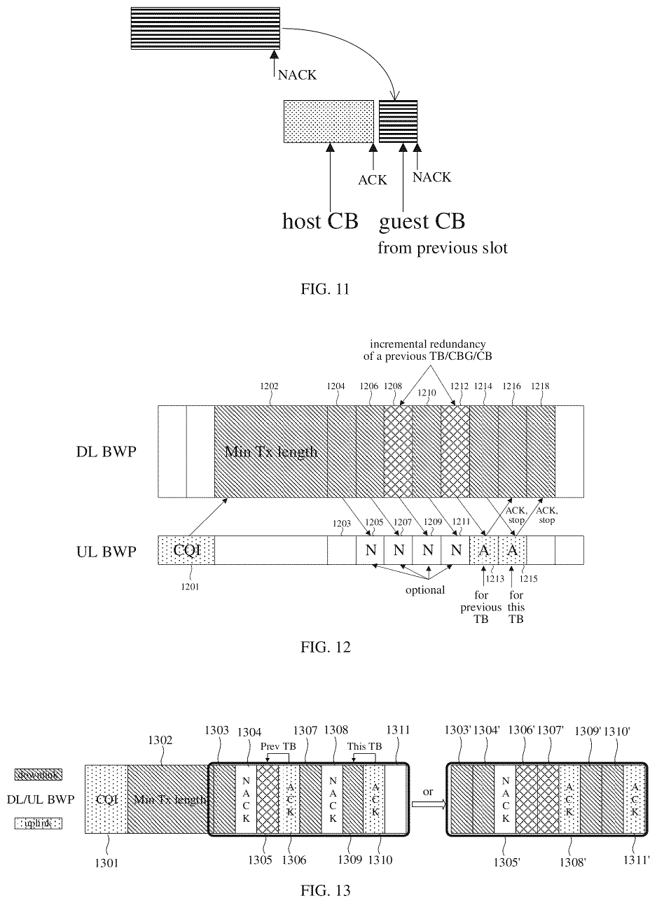

An illustration of scheduling the host CB and guest CB is shown in FIG. 11. There can be three scheduling methods (use CB as example), as seen below.

One scheduling method (Scheduling 2a: basic) is: always schedule host CB first; once host CB is decoded successfully, share all remaining symbols to earliest undecoded guest CBS.

For example, referring to FIG. 9, the host CB (e.g., the codeword of User-4) is scheduled on slot4 first. Once the codeword of User-4 is decoded successfully without occupying the whole slot4 (i.e., without occupying all the symbols in slot4), the remaining part of slot4 may be shared for transmission of other codewords. In such case, the remaining symbols in slot4 may be shared for transmission of previous undecoded guest CBs.

In an implementation, as shown in FIG. 9, the remaining symbols in slot4 may be shared for transmission of the earliest undecoded guest CBs. For example, the codeword of User-2 is transmitted earlier than the codeword of User-3, and the codeword of User-3 is transmitted earlier than the codeword of User-4. In addition, neither of the codeword of User-2 and the codeword of User-3 is decoded successfully before transmission of the codeword of User-4. In such case, the codeword of User-2 may be considered as the earliest undecoded guest codeword. Once the codeword of User-4 is decoded successfully without occupying the whole slot4 (i.e., without occupying all the symbols in slot4), the remaining part of slot4 may be shared for transmission of the codeword of User-2.

In another scheduling method (scheduling 2b: unlimited buffer), a certain number of symbols or a certain proportion of a slot may be used for transmission of the host CB to guarantee transmission of the host CB. For example, always guarantee host CB within dedicated symbols (e.g., 9/12 slot). In this method, once host CB is decoded successfully, share all remaining symbols to earliest undecoded guest CBs. If host CB fails to be decoded within dedicated symbols (e.g., 9/12 slot), schedule earliest failed guest CB in shareable symbols (e.g., 3/12 slot); In other words, shareable symbols can be punctured. In the case where the host CB is not decoded successfully within dedicated symbols, the remaining RVs of the host CB may be transmitted in subsequent slots by puncturing other CB(s).

In yet another scheduling method (scheduling 2c: limited buffer), which is same as/similar to 2b, except discard an undecoded CB after X slots (X=5); if a CB is not decoded after a certain number of slots, the CB may be discarded.

The present disclosure provides a method for channel coding design. Both polar codes and LDPC codes can be employed for our scheme.

### For Polar Codes:

Length-Nₘₐₓ mother code is divided into a number of subblocks (e.g., 32 subblocks), and a decoding attempt is performed after receiving each subblock. Assume each subblock has B bits. In addition to 32 subblocks, we can also divide into 4, 8, 16 and 64 subblocks (the length-Nₘₐₓ mother code may be divided into 4, 8, 16 or 64 subblocks).

Transmitting according to the subblock interleaver, and if the resource allocated for a transmission has M bits, we transmit floor (M/B)*B bits and repeat the extra M-floor (M/B)*B bits.

Start decoding when M>K or M>Mₘᵢₙ, where Mₘᵢₙ is the minimum code length for decoding, K is the length of systematic bits, and report ACK/NACK after each subblock. Note that NACK may not be reported.

### LDPC Codes can Also be Used:

Ensure that systematic bits and core parity bits are transmitted, and only puncture the extension parity bits.

### Redundancy Version Design:

No starting position will be defined for each redundancy version. The transmitter continues to transmit the next code bits in the circular buffer whenever it gets the chance, and the receiver assumes so. In such case, there is no need to specify redundant versions. Thanks to the new redundancy version design (no pre-defined starting position), better coding gain may be achieved.

The puncturing of the incumbent transmission need to be robust such that certain code bits that are less vulnerable to puncturing will be mapped to REs reserved for potential puncturing.

The present disclosure provides yet another method for data transmission. To support the above PROQ scheme, new frame structures are proposed in the present disclosure.

One possible scenario is FDD. The PROQ-FDD design comes convenient because the potential feedback can be sent in a timely manner. This promotes the benefit from early termination. Usually the NACK transmission is not needed, which both saves UL power and reduces interference. An ACK is reported upon successful decoding to stop the DL transmission.

In FDD scenario, for Feedback design, there may be implicit UCI-to-PDSCH association. In addition, UL ACK/NACK has a fixed delay to its corresponding PDSCH. The fixed delay can be x symbol/mini-slot/slot. E.g., x=1.

FIG. 12 shows an example of a frame structure in FDD scenario. In FIG. 12, each block represents a time-frequency resource block. In FDD scenario, there is downlink data transmission on one bandwidth part (BWP), and uplink CQI/NACK/ACK on another bandwidth part (BWP). For example, downlink data is transmitted on DL BWP, and uplink CQI/NACK/ACK is transmitted on UL BWP.

In FIG. 12, resource 1201 is used for transmitting CQI (e.g., open-loop CQI), resource 1202 is used for transmitting RV(s) of the minimum transmission length. There is a feedback opportunity (in other words, resource used/reserved for transmitting feedback) corresponding to each RV after RV(s) of the minimum transmission length is transmitted. In addition, there may be implicit UCI-to-PDSCH association. For example, a feedback transmitted on resource 1205 corresponds to the RV(s) of a TB/CBG/CB transmitted on resource 1204. Likewise, feedbacks transmitted on resource 1207, resource 1209, resource 1211, resource 1213 and resource 1215 correspond to the RVs of TBs/CBGs/CBs transmitted on resource 1206, resource 1208, resource 1210, resource 1212, and resource 1214, respectively. In addition, a feedback transmitted on resource 1203 corresponds to the RV(s) of minimum transmission length transmitted on resource 1202. In this case, UL ACK/NACK may have a fixed delay to the RV transmitted on corresponding PDSCH. For example, duration of each resource 1203, 1204, 1205,1206, 1207, . . . , 1218 is 1 mini-slot, and the UL ACK/NACK transmitted on a resource (e.g., resource 1205) may have a fixed delay (e.g., 1 mini-slot) to its corresponding PDSCH (e.g., resource 1204). In addition, a feedback may not be transmitted before the complete reception of RV(s) of minimum transmission length.

In the example shown in FIG. 12, a previous TB is not decoded successfully before the BS starts to transmit the current TB. In such case, the current TB is punctured by the previous TB (e.g., incremental redundancy of the previous TB). Resources 1202, 1204, 1206, 1210, 1214, 1216, and 1218 are used to transmit RV(s) of the current TB, while resources 1208 and 1212 are used to transmit RV(s) of the previous TB.

In the example shown in FIG. 12, the previous TB (or CBG, CB) is still not decoded successfully after the RV of the previous TB transmitted on resource 1208 is received and decoded (or decoded together with previous RVs of the previous TB). The UE may or may not transmit a NACK on resource 1209 (since resource 1209 corresponds to the RV(s) of the previous TB transmitted on resource 1208). The previous TB is decoded successfully after the RV(s) of the previous TB transmitted on resource 1212 is received and decoded (or decoded together with previous RVs of the previous TB). In this case, an ACK is transmitted on resource 1213. Since the feedback transmitted on resource 1213 corresponds to the RV(s) of the previous TB transmitted on resource 1212, after receiving the ACK transmitted on resource 1213, the BS may know that the RV(s) of the previous TB transmitted on resource 1212 has been decoded successfully (or decoded successfully together with previous RVs of the previous TB). In other words, the BS knows that the previous TB is decoded successfully once it receives the ACK corresponding to the previous TB, and then the BS may stop transmitting the RVs of the previous TB. The current TB will no longer be punctured for transmission of the previous TB that has already been decoded successfully. For example, resource 1216 may be used for transmission of RV(s) of the previous TB in a case where the previous TB is not decoded successfully. However, if the previous TB has already been decoded successfully, resource 1216 will no longer be used for transmission of RV(s) of the previous TB; instead, resource 1216 will be used for transmission of RV(s) of the current TB.

In the example shown in FIG. 12, the current TB is decoded successfully after the RV(s) of the previous TB transmitted on resource 1214 is received and decoded (or decoded together with previous RVs of the current TB). In this case, an ACK is transmitted on resource 1215. Since the feedback transmitted on resource 1215 corresponds to the RV(s) of the current TB transmitted on resource 1214, after receiving the ACK transmitted on resource 1215, the BS may know that the RV(s) of the current TB transmitted on resource 1214 has been decoded successfully (or decoded successfully together with previous RVs of the current TB). In other words, the BS knows that the current TB is decoded successfully once it receives the ACK corresponding to the current TB, and then the BS may stop transmitting the RVs of the current TB.

In FIG. 12, the BS receives the ACK transmitted on resource 1215 while transmitting an RV(s) of the current TB on resource 1216. Therefore, when the BS receives the ACK transmitted on resource 1215, RV(s) of the current TB is still being transmitted on resource 1216 and accordingly received by the UE. However, since the current TB has already been decoded successfully, the UE no longer needs to receive or decode the RV(s) of the current TB transmitted on resource 1216. In one example, the RV(s) of the current TB transmitted on resource 1216 is/are not received by the UE. In another example, the RV(s) of the current TB transmitted on resource 1216 is/are received but not decoded by the UE.

Since the BS has received the ACK transmitted on resource 1215, it will stop transmitting the RVs of the current TB. For example, the RVs of the current TB will not be transmitted on any resource after resource 1216. After stopping transmitting RVs of the current TB, the BS may start transmitting RVs of a next TB. For example, resource 1218 may be used for transmission of RV(s) of the next TB.

In addition, in order to ensure that there is a feedback opportunity for each RV, a duration of transmitting the RV on each resource block of the DL BWP may be the same as a duration of a reporting window of the feedback on the UL BWP. For example, resource 1205 and resource 1204 may be of the same length in time domain.

Note that the previous TB and the current TB may be transmitted to the same UE or different UEs. For example, the previous TB is transmitted to UE1, and the current TB is transmitted to UE2. In such case, UE1 may turn off its receiving antenna(s) once it has decoded the received TB (e.g., the previous TB) successfully. In other words, if UE1 has successfully received the TB and has no more TB(s) to transmit/receive, it may turn the RF chain (including antenna) off. Whether UE1 will further transmit/receive may depend on BS scheduling.

In FDD scenario, the puncture pattern may be pre-defined. The puncture pattern includes, e.g., evenly distributed, reverse-order puncturing, or puncturing from one/two ends.

In an implementation, the puncture pattern may be signaled by RRC/DCI.

In another implementation, the puncture pattern may be pre-defined in a table, with specific option (index) signaled.

Another possible scenario is TDD. Special frame structure needs to be defined for TDD, and co-designed with SBFD.

FIG. 13 shows an example frame structure in TDD scenario. In FIG. 13, each block represents a time-frequency resource block. In TDD scenario, there is downlink data transmission and uplink CQI/NACK/ACK transmission on the same bandwidth part (BWP).

In TDD scenario, downlink data and uplink CQI/NACK/ACK are transmitted on a same BWP (e.g., DL/UL BWP) in different durations of time. Some symbols/sub-slots are reserved for possible ACK transmission, and are inserted between DL transmissions. In such case, some resources may be reserved for transmission of feedback from the UE, enabling fine-grained incremental redundancy with more feedback opportunities during data transmission. In some embodiments, some symbols/mini-slots may be reserved for uplink transmission, and uplink NACK/ACK can be transmitted on the reserved symbols/mini-slots.

In TDD scenario, some symbols/sub-slots may be reserved for possible ACK transmission, and are inserted between DL transmissions. The frame structure can be flexibly defined to adapt to various scenarios. For example, the proportion of UL and DL symbols can be flexibly configured by some patterns:
   |D|U|D|U|D|U| pattern; or
   |D|D|U|D|D|U| pattern (“D” represents DL, and “U” represents UL).

As shown in FIG. 13, resource 1301 is used for transmission of CQI; resource 1302 is used for transmission of RV(s) of the current TB of minimum transmission length. In the example of | D|U|D|U|D|U| pattern, resource 1303 is used for transmission of RV(s) of the current TB; resource 1304 is reserved for transmission of UE feedback corresponding to the current TB; resource 1305 is used for transmission of RV(s) of the previous TB; resource 1306 is reserved for transmission of UE feedback corresponding to the previous TB; resource 1307 is used for transmission of RV(s) of the current TB; resource 1308 is reserved for transmission of UE feedback corresponding to the current TB; resource 1309 is used for transmission of RV(s) of the current TB; resource 1310 is reserved for transmission of UE feedback corresponding to the current TB.

In the example of |D|U|D|U|D|U| pattern shown in FIG. 13, the previous TB is decoded successfully after RV(s) of the previous TB transmitted on resource 1305 is/are received and decoded by the UE. Accordingly, the UE transmits an ACK on resource 1306. Since the feedback transmitted on resource 1306 corresponds to the RV transmitted on resource 1305, once the BS receives the ACK transmitted on resource 1306, the BS may know that the RV transmitted on resource 1305 is decoded successfully (or decoded successfully together with previous RVs). In other words, the BS may know that the previous TB has been decoded successfully. In such case, RVs of the previous TB will no longer be transmitted after it is decoded successfully.

In the example of |D|U|D|U|D|U| pattern shown in FIG. 13, the current TB is decoded successfully after RV(s) of the current TB transmitted on resource 1309 is/are received and decoded by the UE. Accordingly, the UE transmits an ACK on resource 1310. Since the feedback transmitted on resource 1310 corresponds to the RV transmitted on resource 1309, once the BS receives the ACK transmitted on resource 1310, the BS may know that the RV transmitted on resource 1309 is decoded successfully (or decoded successfully together with previous RVs). In other words, the BS may know that the current TB has been decoded successfully. In such case, RVs of the current TB will no longer be transmitted after it is decoded successfully. In such case, resource 1311 will not be used to transmit RVs of the current TB. In addition, since the current TB has not been decoded successfully after RVs of the current TB transmitted on resources 1303 and 1307 are received and decoded by the UE, the UE may transmit a NACK or may not transmit a feedback on resources 1304 and/or 1308, which correspond to resources 1303 and 1307 respectively.

In the example of |D|U|D|U|D|U| pattern shown in FIG. 13, resources 1303′ and 1304′ are used for transmission of RVs of the current TB; resource 1305′ is reserved for transmission of UE feedback corresponding to the current TB; resources 1306′ and 1307′ are used for transmission of RVs of the previous TB; resource 1308′ is reserved for transmission of UE feedback corresponding to the previous TB; resources 1309′ and 1310′ are used for transmission of RVs of the current TB; and resource 1311′ is reserved for transmission of UE feedback corresponding to the current TB.

In the example of |D|U| D|U|D|U| pattern shown in FIG. 13, the current TB has not been decoded successfully after RVs of the current TB transmitted on resources 1303′ and 1304′ are received and decoded by the UE, and the UE may accordingly transmit a NACK or may not transmit a feedback on resource 1305′, which corresponds to resources 1303′ and 1304′. The previous TB is decoded successfully after RVs of the previous TB transmitted on resources 1306′ and 1307′ are received and decoded by the UE, and the UE may accordingly transmit an ACK on resource 1308′, which corresponds to resources 1306′ and 1307′. The current TB is decoded successfully after RVs of the current TB transmitted on resources 1309′ and 1310′ are received and decoded by the UE, and the UE may accordingly transmit an ACK on resource 1311′, which corresponds to resources 1309′ and 1310′.

Note that the allocation of symbols/sub-slots between DL transmission and UL ACK can have various patterns. One way is to allocate an ACK symbol after each DL transmission symbol. Or, we can let multiple consecutive data symbols be followed by an ACK/NACK. Discontinuous punctured pattern in the present disclosure provides time for feedback (ACK). The puncture ratio and cross-slot puncture pattern makes the PROQ scheme standard friendly.

The TDD design may be less spectrum efficient, but applies to a wider range of scenarios.

Another possible design is TDD with sub-band full-duplex (SBFD). This design can improve spectrum efficiency upon pure TDD. The difference is, uplink NACK/ACK can be transmitted on reserved sub-band and symbols/mini-slots.

In TDD-SBFD, sub-band(s) may be reserved for UE feedback. In other words, the sub-band(s) is/are reserved for the BS to listen for feedback from a UE or more than one UE (in a case where UL resources are multiplexed by multiple UEs).

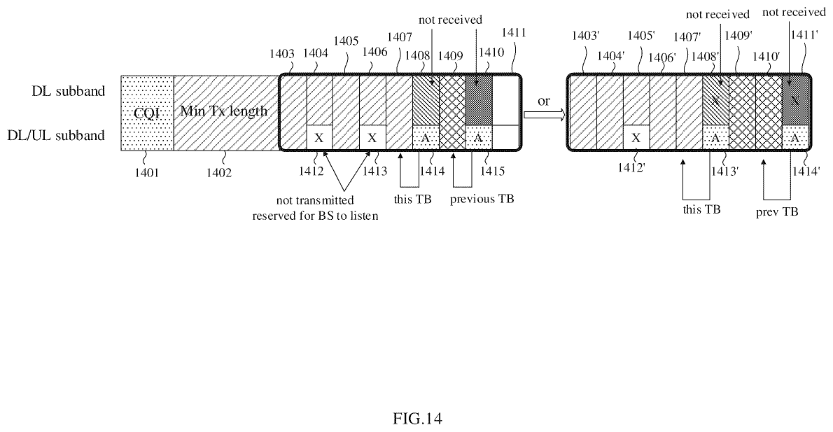

In one example shown in FIG. 14, resource 1401 is used for transmission of CQI; resource 1402 is used for transmission of RVs of Min Tx length of the current TB. Resources 1403, 1404, 1405, 1406, 1407, and 1408 are used for transmission of RVs of the current TB. Resources 1409 and 1410 are used for transmission of RVs of the previous TB. Resources 1412, 1413, 1414 and 1415 are reserved sub-bands for the BS to listen for feedback.

The current TB (e.g., TB1) is not decoded successfully after RVs of TB1 transmitted on resources 1402 and 1403 are decoded. Accordingly, the UE may feed back a NACK on resource 1412, which is optional. TB1 is still not decoded successfully after RVs of TB1 transmitted on resources 1404 and 1405 are decoded. Accordingly, the UE may feed back a NACK on resource 1413, which is optional. TB1 is finally decoded successfully after RVs of TB1 transmitted on resources 1406 and 1407 are decoded. Accordingly, the UE may feed back an ACK on resource 1414. In such case, since TB1 has already been decoded successfully, RVs of TB1 will not be transmitted on any resource after resource 1408. In addition, RVs of TB1 transmitted by the BS on resource 1408 may not be received by the UE.

TB1 is punctured by the previous TB (e.g., TB0). RV(s) (e.g., remaining RV) of TB0 are transmitted on resource 1409 by puncturing TB1. TB0 is decoded successfully after RV(s) of TB0 transmitted on resource 1409 is/are received and decoded. Accordingly, the UE feeds back an ACK on resource 1415. In such case, since TB0 has already been decoded successfully, RVs of TB0 will not be transmitted on any resource after resource 1410. In addition, RVs of TB0 transmitted by the BS on resource 1410 may not be received by the UE.

In another example shown in FIG. 14, resources 1403′, 1404′, 1405′, 1406′, 1407′, and 1408′ are used for transmission of RVs of the current TB. Resources 1409′, 1410′ and 1411′ are used for transmission of RVs of the previous TB. Resources 1412′, 1413′, and 1414′ are reserved sub-bands for the BS to listen for feedback.

The current TB (e.g., TB1) is not decoded successfully after RVs of TB1 transmitted on resources 1403′ and 1404′ are decoded. Accordingly, the UE may feed back a NACK on resource 1412′, which is optional. TB1 is decoded successfully after RVs of TB1 transmitted on resources 1405′, 1406′, and 1407′ are decoded. Accordingly, the UE may feed back an ACK on resource 1413′. In such case, since TB1 has already been decoded successfully, RVs of TB1 will not be transmitted on any resource after resource 1408′. In addition, RVs of TB1 transmitted by the BS on resource 1408′ may not be received by the UE.

TB1 is punctured by the previous TB (e.g., TB0). RVs (e.g., remaining RVs) of TB0 are transmitted on resource 1409′, 1410′, and 1411′ by puncturing TB1. TB0 is decoded successfully after RV(s) of TB0 transmitted on resource 1409′ and 1410′ is/are received and decoded. Accordingly, the UE feeds back an ACK on resource 1414′. In such case, since TB0 has already been decoded successfully, RVs of TB0 will not be transmitted on any resource after resource 1411′. In addition, RVs of TB0 transmitted by the BS on resource 1411′ may not be received by the UE.

As described above, in the design of TDD-SBFD, some sub-bands are reserved for UE feedback. In such case, compared with pure TDD, less resource is reserved. In this way, spectrum efficiency may be improved.

The present disclosure provides another method for data transmission.

In some embodiments, carrier aggregation is expected where the carriers from one or more bandwidth parts (BWPs) are used for transmission. The carrier aggregation may be referred to as “virtual full duplex.” In such case, there may be dedicated uplink BWP and/or uplink carriers for low-latency uplink transmission of feedback. For example, there may be dedicated uplink BWP and/or dedicated uplink carriers for real-time feedbacks (e.g., ACK/NACK). Through carrier aggregation, frequent switch between uplink and downlink transmission may be avoided, and spectrum efficiency may be improved.

In an implementation, the BS may configure the feedbacks to be transmitted on the same BWP/carrier. In another implementation, the BS may configure the feedbacks to be transmitted on multiple BWPs/carriers. For example, feedbacks of different codewords may be transmitted on different BWPs/carriers.

The BS may inform the UE of the BWPs/carriers to be used for transmitting feedbacks by sending second information to the UE. The second information is also referred to as resource information. For example, the resource information may include the BWP configuration indicating the BWP(s) for transmission of the feedbacks. The BWP(s) may be identified by BWP index(es)/ID(s). For another example, the resource information may include carrier configuration indicating the carrier(s) for transmission of the feedbacks. The carrier(s) may be identified by carrier index(es)/ID(s). In such case, the resource information may indicate the BWP(s)/carrier(s) for multiple feedbacks. In other words, the resource information may indicate resources for multiple feedback opportunities. In this way, the feedback(s) may be transmitted in a timely manner, and timely report of decoding results (among CSI and others) may be ensured. The resource information may be carried in RRC or DCI. The feedback(s) (e.g., multiple-ACK/NACK) may be carried in Uplink Control Information (UCI), and the real-time feedbacks may be referred to as real-time-type UCI report.

In an implementation, in RRC signaling, there may be a field to describe the resource information to transmit the feedbacks. The BWP(s)/carrier(s) may be identified by BWP ID(s)/carrier ID(s).

For example, in RRC signaling, there may be a field indicating one or more BWPs that are configured for transmission of the feedbacks (e.g., multi-ACK UCI report).

BWP-Uplink ::= SEQUENCE {

| | |
|---|---|
| bwp-Id | BWP-Id, |
| bwp-Common | BWP-UplinkCommon |
| bwp-Dedicated | BWP-UplinkDedicated |
| bwp-Realtime | BWP-UplinkRealTime |

...
}

| BWP- UplinkRealTime ::= | SEQUENCE { | |
|---|---|---|
| pucch-rt-Config | SetupRelease {PUCCH-rt-Config } | OPTIONAL,--Need M |

...
}
PUCCH-rt-Config::{
multi-ACK-carrierId SEQUENCE (SIZE (1..maxNofCarrier)) OF PUCCH-multiACK-carrierId
}

Once the UE receives RRC signaling, the UE may know the carrier(s) for transmitting the feedbacks according to the carrierId, and the UE may transmit feedbacks on the carrier(s).

For another example, in DCI configurations, there may be one or more field indicating one or more BWPs and/or carriers that are configured for transmission of the feedbacks (e.g., multi-ACK UCI report).

In DCI configurations, it is also possible that the specific BWP index and/or carrier index are left for DCI to configure.

For example, there may be a modified field in the frequency domain resource assignment, in which a set of bits are defined to indicate the BWP index and/or carrier index configured in BWP-UplinkRealTime.

For another example, there may be a modified field in the time domain resource assignment, in which a set of bits are defined to indicate the timing (e.g., slot and/or symbol indexes, offsets) to transmit the UCI (including the multiple ACK/NACK).

In the UE procedure, after receiving the resource information (e.g., BWP configuration and/or carrier configuration in RRC, which may contain a set of available BWP indexes and/or carrier indexes), the UE may know which resources (BWP(s) and/or carrier(s)) are for transmission the real-time feedbacks. For example, if the UE receives the BWP-UplinkRealTime configuration carried in RRC, and indicate a specific index corresponding to an available configuration, the UE may obtain the BWP index(es), carrier index(es) and symbol index(es) for the new real-time-type UCI report.

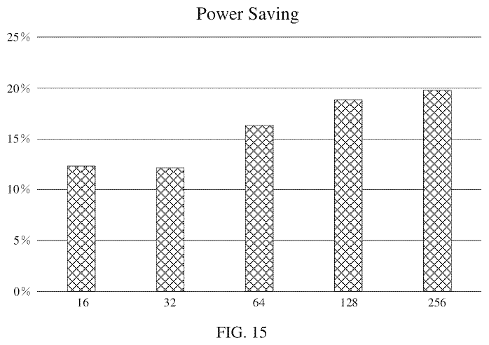

As an example, the power saving result in a multi-cell multi-user setting is shown in FIG. 15, where the x-axis is the number of UEs in the simulated area.

Some insights can be derived from the above result:

The first source of gain is the better rate adaptability by rateless coding than IR-HARQ.

Earlier stopping than IR-HARQ, which has to transmit a full RV every time.

The second source of gain is the interference reduction as a result of the coded waterfilling.

The stronger interference, the more additional gain can be observed from coded waterfilling.

Compared to legacy HARQ, the advantageous effects are, higher throughput, lower latency, save power, reduce interference, and less sensitive to imperfect channel estimation.

Some embodiments of the present disclosure provide a computer-readable storage medium (e.g., a non-transitory computer-readable storage medium). The computer-readable storage medium has stored thereon program instructions that, when run on a network device/terminal device, cause the network device/terminal device to execute one or more steps of the method for beam management as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes program instructions carried on a non-transitory computer-readable storage medium. When executed on a network device/terminal device, the computer program instructions cause the network device/terminal device to perform one or more steps of the method for data transmission as described in the above embodiments.

Beneficial effects of the computer-readable storage medium and the computer program product are the same as the beneficial effects of the method for data transmission as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

In some aspects of the present disclosure, there is provided a computer program comprising instructions. The instructions, when executed by a processor, may cause the processor to implement a method of the present disclosure.

In some aspects of the present disclosure, there is provided an integrated circuit. The integrated circuit includes one or more logic circuits for executing the steps of the method for data transmission of the present disclosure.

In some aspects of the present disclosure, there is provided an apparatus comprising means (e.g., at least one processor) to implement a method of the present disclosure. The apparatus may be device (that is, a terminal device or a network device) or a module or component in the device. The at least one processor may execute instructions stored in a computer-readable medium to implement the method.

The apparatus may be a communication device or an apparatus implemented in a communication device. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components.

The solutions described in the disclosure is applicable to a next generation (e.g. sixth generation (6G) or later) network, or a legacy (e.g. 5G, 4G, 3G or 2G) network. The proposed method applies to a wide range of communication networks, such as 5G+, 6G, WiFi, NTN and distributed or self-organized networks.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

The terms “apparatus” and “device” are used exchangeable.

In the disclosure, the word “a” or “an” when used in conjunction with the term “comprising” or “including” in the claims and/or the specification may mean “one,” but it is also consistent with the meaning of “one or more,” “at least one,” and “one or more than one” unless the content clearly dictates otherwise. Similarly, the word “another” may mean at least a second or more unless the content clearly dictates otherwise.

In the disclosure, the words “first,” “second,” etc., when used before a same term (e.g., UE, or an operating step) does not mean an order or a sequence of the term. For example, the “first UE” and the “second UE,” means two different UEs without specially indicated, and similarly, the “first step” and the “second step” means two different operating steps without specially indicated, but does not mean the first step have to happen before the second step. The real order depends on the logic of the two steps.

The terms “coupled,” “coupling,” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The terms “receive,” “detect,” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive,” “detect” and “decode” may indicate different procedure at receiving side to obtain the information. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

The following are acronyms, abbreviations, and key terms:

| | |
|---|---|
| | Acronym/ |
| Full Name | Abbreviation/Initialism |

Communication related

| | |
|---|---|
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low latency communications | uRLLC |
| Enhanced mobile broadband | eMBB |
| massive Machine Type Communications | mMTC |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |
| Successive cancellation | SC |
| Successive cancellation list | SCL |
| Belief propagation | BP |

1. A method for data transmission, comprising:
sending first one or more sets of bits of a first codeword on a first resource;
sending one or more sets of bits of a second codeword on a first part of a second resource;
sending second one or more sets of bits of the first codeword on a second part of the second resource;
receiving feedback indicating the first codeword is decoded successfully; and
terminating the sending the second one or more sets of bits of the first codeword in response to the feedback.

2. The method of claim 1, further comprising:
sending a first indication for indicating at least one of: a proportion of the second part of the second resource in the second resource, a quantity of the second part of the second resource, or a distribution of the second part of the second resource in the second resource.

3. The method of claim 2, wherein:
the second part of the second resource is evenly distributed in the second resource; or
the second part of the second resource is distributed at a beginning of the second resource, at an end of the second resource, or at both the beginning and the end of the second resource.

4. The method of claim 2, wherein the second part of the second resource is used for transmitting parity bits.

5. The method of claim 1, further comprising:
sending one or more sets of bits of a third codeword on a first part of a third resource;
sending third one or more sets of bits of the first codeword on a second part of the third resource; and
sending second one or more sets of bits of the second codeword on a third part of the third resource.

6. A method for data transmission, comprising:
receiving first one or more sets of bits of a first codeword on a first resource;
receiving one or more sets of bits of a second codeword on a first part of a second resource;
receiving second one or more sets of bits of the first codeword on a second part of the second resource; and
sending feedback indicating the first codeword is decoded successfully.

7. The method of claim 6, further comprising:
receiving a first indication for indicating at least one of: a proportion of the second part of the second resource in the second resource, a quantity of the second part of the second resource, or a distribution of the second part of the second resource in the second resource.

8. The method of claim 7, wherein:
the second part of the second resource is evenly distributed in the second resource; or
the second part of the second resource is distributed at a beginning of the second resource, at an end of the second resource, or at both the beginning and the end of the second resource.

9. The method of claim 7, wherein the second part of the second resource is used for transmitting parity bits.

10. The method of claim 6, further comprising:
receiving one or more sets of bits of a third codeword on a first part of a third resource;
receiving third one or more sets of bits of the first codeword on a second part of the third resource; and
receiving second one or more sets of bits of the second codeword on a third part of the third resource.

11. An apparatus for data transmission, comprising:
at least one processor; and
at least one memory coupled to the at least one processor, the at least one memory storing at least part of instructions that, when executed by the at least one processor, causes the apparatus to perform:
sending first one or more sets of bits of a first codeword on a first resource;
sending one or more sets of bits of a second codeword on a first part of a second resource;
sending second one or more sets of bits of the first codeword on a second part of the second resource;
receiving feedback indicating the first codeword is decoded successfully; and
terminating the sending the first one or more sets of bits of the first codeword in response to the feedback.

12. The apparatus of claim 11, wherein the at least part of the instructions further causes the apparatus to perform:
sending a first indication for indicating at least one of: a proportion of the second part of the second resource in the second resource, a quantity of the second part of the second resource, or a distribution of the second part of the second resource in the second resource.

13. The apparatus of claim 12, wherein:
the second part of the second resource is evenly distributed in the second resource; or
the second part of the second resource is distributed at a beginning of the second resource, at an end of the second resource, or at both the beginning and the end of the second resource.

14. The apparatus of claim 12, wherein the second part of the second resource is used for transmitting parity bits.

15. The apparatus of claim 11, wherein the at least part of the instructions further causes the apparatus to perform:
sending one or more sets of bits of a third codeword on a first part of a third resource;
sending third one or more sets of bits of the first codeword on a second part of the third resource; and
sending second one or more sets of bits of the second codeword on a third part of the third resource.

16. An apparatus for data transmission, comprising:
at least one processor; and
at least one memory coupled to the at least one processor, the at least one memory storing at least part of instructions that, when executed by the at least one processor, causes the apparatus to perform:
receiving first one or more sets of bits of a first codeword on a first resource;
receiving one or more sets of bits of a second codeword on a first part of a second resource;
receiving second one or more sets of bits of the first codeword on a second part of the second resource; and
sending feedback indicating the first codeword is decoded successfully.

17. The apparatus of claim 16, wherein the at least part of the instructions further causes the apparatus to perform:
receiving a first indication for indicating at least one of: a proportion of the second part of the second resource in the second resource, a quantity of the second part of the second resource, or a distribution of the second part of the second resource in the second resource.

18. The apparatus of claim 17, wherein:
the second part of the second resource is evenly distributed in the second resource; or
the second part of the second resource is distributed at a beginning of the second resource, at an end of the second resource, or at both the beginning and the end of the second resource.

19. The apparatus of claim 17, wherein the second part of the second resource is used for transmitting parity bits.

20. The apparatus of claim 16, wherein the at least part of the instructions further causes the apparatus to perform:
receiving one or more sets of bits of a third codeword on a first part of a third resource;
receiving third one or more sets of bits of the first codeword on a second part of the third resource; and
receiving second one or more sets of bits of the second codeword on a third part of the third resource.
